(19) United States
(12) Patent Application Publication
(10) Pub. No.: US 2025/0200823 A1
(43) Pub. Date: Jun. 19, 2025

(54) MODIFYING DIGITAL DESIGNS TO ALIGN THE CIRCUMFERENCES OF CONCENTRICALLY PLACED RADIAL-REPEAT OBJECTS

(71) Applicant: Adobe Inc., San Jose, CA (US)

(72) Inventors: Vivek Agrawal, Noida (IN); Deepanjana Chakravarti, San Mateo, CA (US)

(21) Appl. No.: 18/543,990

(22) Filed: Dec. 18, 2023

(51) Int. Cl. G06T 11/00; G06F 3/04845; G06T 3/60; G06T 7/33

(52) U.S. Cl. CPC G06T 11/00; G06F 3/04845; G06T 3/60; G06T 7/33; G06T 2200/24

(57) ABSTRACT

The present disclosure relates to systems, methods, and non-transitory computer-readable media that align radial-repeat objects portrayed within a digital design (e.g., a design having vector graphics). For instance, in one or more embodiments, the disclosed systems detect a user interaction for modifying a first radius of a first radial-repeat object portrayed within a digital design. The disclosed systems also extract a second radius of a second radial-repeat object portrayed within the digital design. In response to the user interaction, the disclosed systems modify the digital design by modifying the first radial-repeat object to align the first radius of the first radial-repeat object with the second radius of the second radial-repeat object.

### BACKGROUND

Recent years have seen significant advancement in hardware and software platforms for editing digital designs. Indeed, as the use of digital designs has become increasingly ubiquitous, systems have developed that provide various digital objects that can be added to digital designs as well as features for manipulating those digital objects. For instance, some systems offer radial-repeat objects that include multiple object instances positioned around a central point. Such systems may further provide features for modifying such radial-repeat objects, such as by changing their circumference (e.g., their radii) or the number, location, or rotation of their object instances.

### SUMMARY

One or more embodiments described herein provide benefits and/or solve one or more problems in the art with systems, methods, and non-transitory computer-readable media that centrally align multiple radial-repeat objects within digital designs by aligning their circumferences. To illustrate, in one or more embodiments, a system edits a digital design (e.g., a design of vector graphics) portraying multiple concentric radial-repeat objects. In response to user input, the system aligns a selected radial-repeat object with another radial-repeat object. In particular, the system aligns the radial-repeat objects by matching their circumferences. To illustrate, in some cases, the system extracts radii for each radial-repeat object, such as by extracting an inner radius and an outer radius. In some implementations, the system determines the radii of a radial-repeat object using bounds appropriation based on logical changes to the radial-repeat object. The system further modifies a radius of the selected radial-repeat object to align with a radius of one of the concentric radial-repeat objects. In this manner, the system flexibly facilitates the accurate alignment of multiple radial-repeat objects to provide precision in the arrangement of such objects in a digital design.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a radial-repeat alignment system operates in accordance with one or more embodiments;

FIG. 2 illustrates an overview diagram of the radial-repeat alignment system aligning radial-repeat objects within a digital design in accordance with one or more embodiments;

FIG. 3 illustrates the radial-repeat alignment system generating a list of radial-repeat objects for a digital design in accordance with one or more embodiments;

FIG. 4 illustrates the radial-repeat alignment system filtering and sorting a list of radial-repeat objects generated for a digital design in accordance with one or more embodiments;

FIG. 5 illustrates the radial-repeat alignment system using sorted lists to align a radial-repeat object with another radial-repeat object in accordance with one or more embodiments;

FIGS. 6A-6F illustrate the radial-repeat alignment system determining radii of a radial-repeat object in accordance with one or more embodiments;

FIG. 7 illustrates an example radial-repeat object for which the radial-repeat alignment system determines radii in accordance with one or more embodiments;

FIG. 8 illustrates another example radial-repeat object for which the radial-repeat alignment system determines radii in accordance with one or more embodiments;

FIG. 9 illustrates yet another example radial-repeat object for which the radial-repeat alignment system determines radii in accordance with one or more embodiments;

FIG. 10 illustrates an example schematic diagram of a radial-repeat alignment system in accordance with one or more embodiments;

FIG. 11 illustrates a flowchart for a series of acts for aligning radial-repeats within a digital design in accordance with one or more embodiments; and

FIG. 12 illustrates a block diagram of an exemplary computing device in accordance with one or more embodiments.

### DETAILED DESCRIPTION

One or more embodiments described herein include a radial-repeat alignment system that aligns the circumferences and radii of concentric radial-repeat objects portrayed within a digital design (e.g., vector-based artwork). For instance, in some embodiments, the radial-repeat alignment system generates a list that maps each radial-repeat object portrayed within a digital design to a center point. Upon detecting user input to modify a radius of one of the radial-repeat objects, the radial-repeat alignment system uses the list to identify one or more radial-repeat objects that are concentric with the selected object. The radial-repeat alignment system further determines radii (e.g., an inner radius and an outer radius) for the selected object and each concentric object. For example, in some cases, the radial-repeat alignment system determines logical translations and/or rotations for each object to appropriate the bounds of a chosen object instance for use in determining the radii. Using the determined radii, the radial-repeat alignment system modifies the selected radial-repeat object to align one of its radii with a radius of one of the concentric radial-repeat objects (e.g., to align the inner radii or the outer radii of the objects).

To illustrate, in one or more embodiments, the radial-repeat alignment system detects a user interaction for modifying a first radius of a first radial-repeat object portrayed within a digital design, wherein the first radial-repeat object comprises a first plurality of object instances positioned along a first circumference at the first radius. The radial-repeat alignment system further extracts a second radius of a second radial-repeat object portrayed within the digital design, wherein the second radial-repeat object comprises a second plurality of object instances positioned along a second circumference at the second radius. In response to the user interaction, the radial-repeat alignment system modifies the digital design by modifying the first radial-repeat object to align the first radius of the first radial-repeat object with the second radius of the second radial-repeat object.

As just indicated, in one or more embodiments, the radial-repeat alignment system modifies digital designs by aligning radial-repeat objects portrayed therein. In particular, the radial-repeat alignment system aligns the radii of the radial-repeat objects. For instance, in some instances, the radial-repeat alignment system aligns the inner or outer radius of one radial-repeat object with the inner or outer radius, respectively, of another radial-repeat object. By aligning the radii of the radial-repeat objects, the radial-repeat alignment system homogenizes their circumferences to provide visual uniformity within the digital design.

For example, in one or more embodiment, the radial-repeat alignment system detects user input for modifying a first radial-repeat object portrayed within the digital design. In particular, the radial-repeat alignment system detects user input to modify a radius of the first radial-repeat object (e.g., user input for increasing or decreasing the radius). In response to the user input, the radial-repeat alignment system identifies a second radial-repeat object portrayed within the digital design, determines a radius of the second radial-repeat object, and modifies the radius of the first radial-repeat object to align with the radius of the second radial-repeat object.

To illustrate, in some embodiments, the radial-repeat alignment system generates a list of all radial-repeat objects portrayed within the digital design. In some instances, the list maps each radial-repeat object to its center point. In some cases, where multiple radial-repeat objects share a center point, the list maps those radial-repeat object to the same center point within the list. Thus, in some embodiments, the radial-repeat alignment system generates a list that indicates which radial-repeat objects portrayed within the digital design are concentric.

In some implementations, upon detecting the user input for modifying the radius of the first radial-repeat object, the radial-repeat alignment system uses the list to identify one or more other radial-repeat objects that are concentric with the first radial-repeat object. For instance, in some cases, the radial-repeat alignment system creates a filtered list by filtering out those radial-repeat objects that are not concentric with the first radial-repeat object. In some instances, the radial-repeat system further filters out those radial-repeat objects that have visibility turned off or are positioned outside the current display area.

In one or more embodiments, the radial-repeat alignment system further determines one or more radii for each radial-repeat object within the filtered list. For example, in some instances, the radial-repeat alignment system determines an inner radius and/or an outer radius for each radial-repeat object. In some cases, the radial-repeat alignment system implements a generalized approach that facilitates the determination of one or more radii of a radial-repeat object regardless of the positioning or rotation of its object instances.

For example, in at least one implementation, the radial-repeat alignment system determines one or more logical changes to a radial-repeat object and determines the one or more radii based on the logical changes. For instance, in some cases, the radial-repeat alignment system logically translates the radial-repeat object to an origin of the digital design. Additionally, the radial-repeat system selects an object instance of the radial-repeat object and logically rotates the object instance to an upright position directly above a center point based on the positioning of the radial-repeat object at the origin. The radial-repeat alignment system further logically translates the radial-repeat object back to its initial position and uses the logically rotated object instance to determine an inner radius and/or an outer radius for the radial-repeat object.

In one or more embodiments, the radial-repeat alignment system sorts the radial-repeat objects within the filtered list based on their determined radii. In some implementations, the radial-repeat alignment system creates two versions of the list—one in which the radial-repeat objects are sorted based on inner radius and another in which the radial-repeat objects are sorted based on outer radius. Using the sorted list(s), the radial-repeat alignment system selects a radial-repeat object (e.g., the second radial-repeat object mentioned above) for use in modifying the radius of the first radial-repeat object. For example, in some cases, the radial-repeat alignment system selects a radial-repeat object having a radius that is within a threshold number of pixels from the radius of the first radial-repeat object.

Thus, in one or more embodiments, the radial-repeat alignment system modifies the first radial-repeat object to align the radii (e.g., the inner or outer radii) of the first radial-repeat object and the other radial-repeat object selected from the sorted list(s). In some cases, the radial-repeat alignment system modifies the first radial-repeat object via a snapping operation. For instance, in some embodiments, the radial-repeat alignment system automatically adjusts the radius of the first radial-repeat object to align with the radius of the radial-repeat object selected from the sorted list. In some implementations, the radial-repeat alignment system further generates and provides a visual guide that indicates the alignment of the radii.

The radial-repeat alignment system provides advantages over conventional systems. Indeed, conventional design editing systems (e.g., systems for editing vector artwork) suffer from several technological shortcomings that result in inflexible, inefficient, and inaccurate operation. To illustrate, conventional systems are typically inflexible in that they fail to offer features for aligning the circumferences (e.g., the radii) of radial-repeat objects within digital designs (e.g., artwork based on vector graphics). Indeed, while some conventional systems enable user input to modify (e.g., increase or decrease) the radius of a selected radial-repeat object, such systems fail to provide features for automatically and precisely aligning a circumference of one radial-repeat object with a circumference of another radial-repeat object.

Additionally, conventional design editing systems often fail to operate efficiently. Indeed, as conventional systems often fail to provide features for automatically aligning the circumferences of radial-repeat objects, such systems tend to rely on user input to manually manipulate the radius of a radial-repeat object to align its circumference with the circumference of another radial-repeat object. Relying on user input, however, is inefficient as it can lead to a significant amount of user interaction with the graphical user interface displaying the digital design. For instance, under conventional systems, a user may need to provide multiple repetitive interactions that repeatedly adjust the circumference of a radial-repeat object to obtain the desired alignment. In some instances, the user may need to provide further interactions for adjusting the display area (e.g., via zooming) to better view the boundaries of the radial-repeat objects and determine whether those boundaries have been properly aligned.

Further, conventional design editing systems also experience problems with accuracy. Indeed, by relying on manual manipulation of radial-repeat objects, conventional systems are often imprecise and prone to human error. In particular, conventional systems often fail to precisely align the circumferences of the radial-repeat objects, leading to a positioning of objects within the digital design that inaccurately reflects the intent of the editing user. Digital designs produced by such shortcomings can suffer from visual unbalance and provide an unpleasant aesthetic.

The radial-repeat alignment system operates with improved flexibility when compared to conventional systems. In particular, the radial-repeat alignment system flexibly offers features for the automatic and precise alignment of radial-repeat objects portrayed within a digital design. Indeed, as described, the radial-repeat alignment system modifies a radial-repeat object selected via user input to automatically align a circumference of the radial-repeat object with a circumference of another radial-repeat object (e.g., to align their radii). Thus, the radial-repeat alignment system flexibly offers features for editing and interacting with radial-repeat objects that are unavailable under conventional systems.

Additionally, the radial-repeat alignment system operates with improved efficiency when compared to conventional systems. For instance, by automatically aligning the circumferences of radial-repeat objects, the radial-repeat alignment system reduces the number of user interactions required to perform such alignments. Indeed, rather than responding to multiple repetitive interactions for readjusting the radius of a given radial-repeat object as may be done under conventional systems, the radial-repeat alignment system performs various behind-the scenes operations that result in the automated alignment of the objects. Accordingly, the radial-repeat alignment system can alignment objects based on a lower number of user interactions.

Further, the radial-repeat alignment system operates with improved accuracy when compared to conventional systems. In particular, by automatically aligning the circumferences of multiple radial-repeat objects, the radial-repeat alignment system avoids the user errors that plague conventional systems. Thus, the radial-repeat alignment system more accurately positions radial-repeat objects in accordance with user intent and provides digital designs with comparatively improved visual balance and a more pleasing aesthetic.

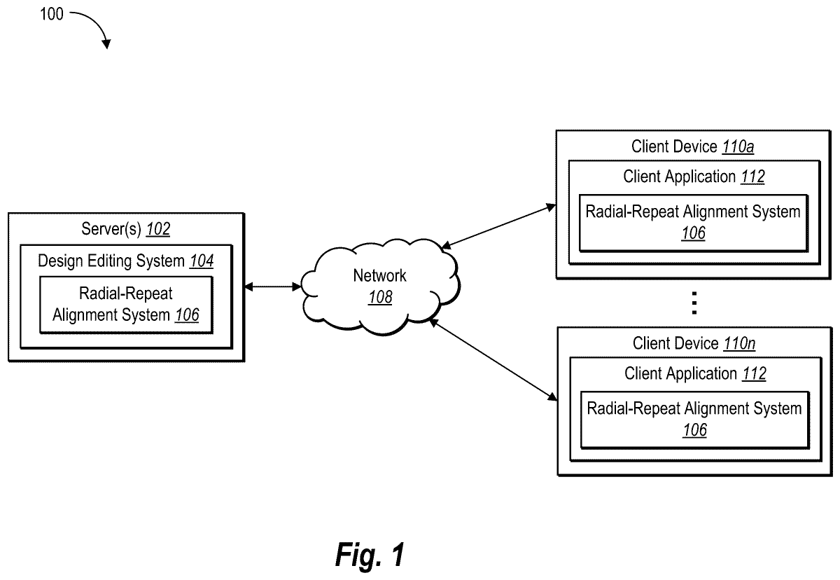

Additional detail regarding the radial-repeat alignment system will now be provided with reference to the figures. For example, FIG. 1 illustrates a schematic diagram of an exemplary system 100 in which a radial-repeat alignment system 106 operates. As illustrated in FIG. 1, the system 100 includes a server(s) 102, a network 108, and client devices 110a-110n.

Although the system 100 of FIG. 1 is depicted as having a particular number of components, the system 100 is capable of having any number of additional or alternative components (e.g., any number of servers, client devices, or other components in communication with the radial-repeat alignment system 106 via the network 108). Similarly, although FIG. 1 illustrates a particular arrangement of the server(s) 102, the network 108, and the client devices 110a-110n, various additional arrangements are possible.

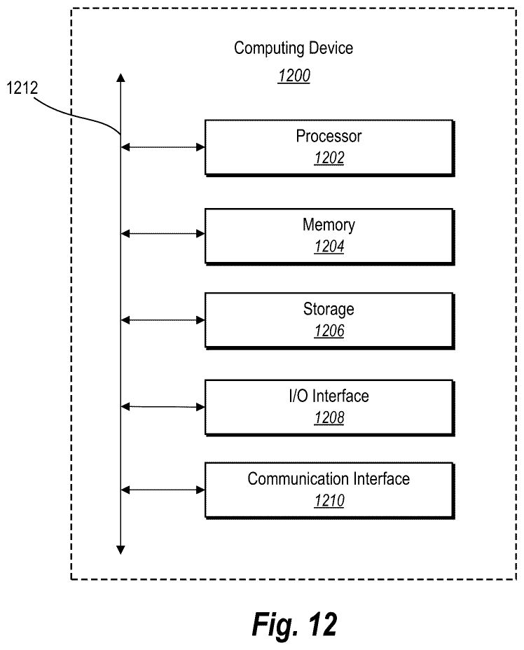

The server(s) 102, the network 108, and the client devices 110a-110n are communicatively coupled with each other either directly or indirectly (e.g., through the network 108 discussed in greater detail below in relation to FIG. 12). Moreover, the server(s) 102 and the client devices 110a-110n include one or more of a variety of computing devices (including one or more computing devices as discussed in greater detail with relation to FIG. 12).

As mentioned above, the system 100 includes the server(s) 102. In one or more embodiments, the server(s) 102 generates, stores, receives, and/or transmits data, including digital designs and modified digital designs. In one or more embodiments, the server(s) 102 comprises a data server. In some implementations, the server(s) 102 comprises a communication server or a web-hosting server.

In one or more embodiments, the design editing system 104 provides functionality by which a client device (e.g., a user of one of the client devices 110a-110n) generates, edits, manages, and/or stores digital designs. For example, in some instances, a client device sends a digital design to the design editing system 104 hosted on the server(s) 102 via the network 108. The design editing system 104 then provides many options that the client device may use to edit the digital design, store the digital design, and subsequently search for, access, and view the digital design. For instance, in some cases, the design editing system 104 provides one or more options that the client device may use to align multiple radial-repeat objects portrayed within a digital design by aligning their circumferences.

In one or more embodiments, the client devices 110a-110n include computing devices that generate or modify digital designs. For example, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that generate or modify digital designs. For example, in one or more embodiments, the client application 112 includes a software application installed on the client devices 110a-110n. Additionally, or alternatively, the client application 112 includes a web browser or other application that accesses a software application hosted on the server(s) 102 (and supported by the design editing system 104).

To provide an example implementation, in some embodiments, the radial-repeat alignment system 106 on the server(s) 102 supports the radial-repeat alignment system 106 on the client device 110n. For instance, in some cases, the radial-repeat alignment system 106 on the server(s) 102 determines radii for radial-repeat objects portrayed within a digital design. The radial-repeat alignment system 106 then, via the server(s) 102 communicates the radii to the client device 110n. The radial-repeat alignment system 106 on the client device 110n responds to user input by aligning a radius of a first radial-repeat object with a radius of a second radial-repeat object based on the communicated radii. In some cases, the radial-repeat alignment system 106 on the client device 110n further generates and provides a visual guide indicating the alignment.

In alternative implementations, the radial-repeat alignment system 106 includes a web hosting application that allows the client device 110n to interact with content and services hosted on the server(s) 102. To illustrate, in one or more implementations, the client device 110n accesses a software application supported by the server(s) 102. The client device 110n provides input to the server(s) 102, such as a digital design to be used and a radial-repeat object to be modified. In response, the radial-repeat alignment system 106 on the server(s) 102 modifies the digital design by modifying a radius of the radial-repeat object to align the radial-repeat object with another radial-repeat object portrayed in the digital design. The server(s) 102 then provides the modified digital design to the client device 110n for display.

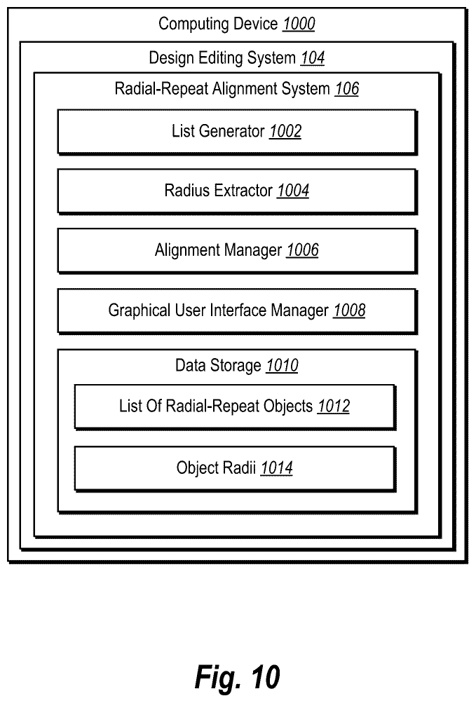

Indeed, the radial-repeat alignment system 106 is able to be implemented in whole, or in part, by the individual elements of the system 100. Indeed, although FIG. 1 illustrates the radial-repeat alignment system 106 implemented with regard to the server(s) 102, different components of the radial-repeat alignment system 106 are able to be implemented by a variety of devices within the system 100. For example, one or more (or all) components of the radial-repeat alignment system 106 are implemented by a different computing device (e.g., one of the client devices 110a-110n) or a separate server from the server(s) 102 hosting the design editing system 104. Indeed, as shown in FIG. 1, the client devices 110a-110n include the radial-repeat alignment system 106. Example components of the radial-repeat alignment system 106 will be described below with regard to FIG. 10.

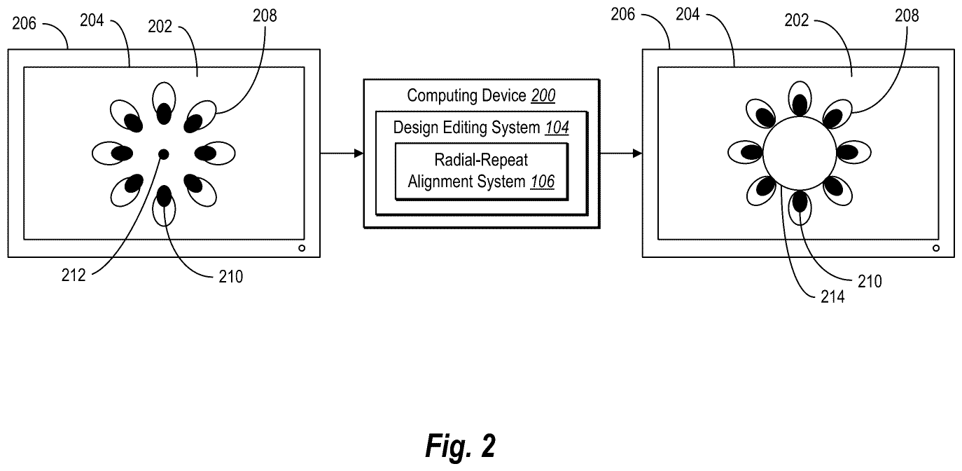

As mentioned above, in one or more embodiments, the radial-repeat alignment system 106 aligns radial-repeat objects portrayed within a digital design by aligning their circumferences. In particular, the radial-repeat alignment system 106 modifies the radii of one radial-repeat object to match the radii of another radial-repeat object. FIG. 2 illustrates an overview diagram of the radial-repeat alignment system 106 aligning radial-repeat objects portrayed within a digital design in accordance with one or more embodiments.

In one or more embodiments, a digital design includes a design of digital visual content. In particular, in some embodiments, a digital design includes a digital representation of a visual design. For instance, in some cases, a digital design includes a digital file of digital data for a visual design that is displayable via a user interface. In some instances, a digital design includes a digitally created design, such as a digitally generated drawing, chart, map, graph, logo, or other graphic. For example, in at least one embodiment, a digital design includes a design (e.g., artwork) composed of vector graphics. In some instances, however, a digital design includes a digital image.

In one or more embodiments, a radial-repeat object includes a digital object composed of a plurality of object instances positioned around a center point. In particular, in some embodiments, a radial-repeat object includes a plurality of object instances positioned in a circular (or partially circular) arrangement around a center point. In some cases, the object instances of a radial-repeat object are identical (e.g., identical in size, shape, and/or color). As such, in some implementations, a radial-repeat object includes a pattern of repeating, identical object instances in a circular (or partially circular) arrangement around its center point. In some instances, however, the object instances of a radial-repeat object differ with respect to at least one attribute. The number, location, and rotation of the object instances of a radial-repeat object varies and/or is adjustable in various embodiments. For example, in at least one implementation, a radial-repeat object includes object instances that are positioned around its center point at regular intervals. In at least one other implementation, however, a radial-repeat object includes object instances that are stacked on one or two sides of its center point. Further, the distance between the center point of a radial-repeat object and its object instances (e.g., the radii of the radial-repeat object) varies and/or is adjustable in various embodiments. In some cases, however, the object instances of a radial-repeat object are positioned at the same distance from its center point. For instance, in some cases, the radial-repeat alignment system 106 modifies the distances between the center of a radial-repeat object and its object instances the same amount to maintain a uniform appearance.

As mentioned, in one or more embodiments, a radial-repeat object includes a plurality of object instances. In one or more embodiments, an object instance includes a distinct component of a radial-repeat object. In particular, in some embodiments, an object instance includes a component that, together with one or more other object instances, makes up a radial-repeat object. In some embodiments, an object instance of a radial-repeat object is distinguishable from the other object instance(s) of the radial-repeat object in its position and/or orientation. For instance, as mentioned above, the object instances of a radial-repeat object are oriented towards its center point in some cases. Accordingly, in some instances, the orientation of an object instance depends on its position with respect to the center point of the radial-repeat object. In some cases, the object instance is further distinguishable by one or more other attributes (e.g., color, size, and/or shape).

Additionally, as mentioned, in one or more embodiments, a radial-repeat object includes a center point. In one or more embodiments, a center point of a radial-repeat object includes a point that defines the center of the radial-repeat object. For instance, in some embodiments, a center point of a radial-repeat object includes a single pixel or a group of pixels that defines the center of the radial-repeat object. To illustrate, as mentioned above, a radial-repeat object includes object instances in a circular arrangement in some cases. Accordingly, in some instances, the center point of the radial-repeat object includes the point defining the center of the circular arrangement.

In one or more embodiments, a radial-repeat object further includes one or more radii. In one or more embodiments, a radius of a radial-repeat object includes a distance between the center point of the radial-repeat object and another point of the radial-repeat object. In particular, in some embodiments, a radius of a radial-repeat object includes a distance between its center point and another point located within or outside of one of its object instances. To illustrate, in some embodiments, an inner radius of a radial-repeat object includes a distance between its center point and a point at the inner boundary of the radial-repeat object. Similarly, in some implementations, an outer radius of a radial-repeat object includes a distance between its center point and a point at the outer boundary of the radial-repeat object. Further, in some instances, a middle radius of a radial-repeat object includes a distance between its center point and some other point between its inner and outer boundaries. As will be discussed in more detail below, in one or more embodiments, the radial-repeat alignment system 106 uses one or more points of an object instance of a radial-repeat object to determine one or more of its radii.

In some embodiments, a radius of a radial-repeat object corresponds to a circumference of the radial-repeat object. In other words, a radius of the radial-repeat object defines a circumference. Thus, in some cases, a radial-repeat object includes an outer circumference that defines its outer boundary, an inner circumference that defines its inner boundary, and one or more middle circumferences defined by corresponding middle radii.

As shown in FIG. 2, the radial-repeat alignment system 106 (operating on a computing device 200) provides a digital design 202 for display within a graphical user interface 204 of a client device 206. As further shown, the digital design 202 portrays a first radial-repeat object 208 and a second radial-repeat object 210 positioned over one another. Additionally, the first radial-repeat object 208 and the second radial-repeat object 210 are concentric, as they share a center point 212. In some cases, the radial-repeat alignment system 106 portrays the center point 212 within the graphical user interface 204. For instance, in some instances, the radial-repeat alignment system 106 portrays the center point 212 as part of the editing process for the digital design 202. In some implementations, however, the radial-repeat alignment system 106 hides the center point 212 from view.

As further shown in FIG. 2, the radial-repeat alignment system 106 object modifies the digital design 202 by aligning the first radial-repeat object 208 and the second radial-repeat object 210. In particular, the radial-repeat alignment system 106 modifies the digital design 202 to align radii of the first radial-repeat object 208 and the second radial-repeat object 210. FIG. 2 more specifically illustrates the radial-repeat alignment system 106 aligning the inner radii of the first radial-repeat object 208 and the second radial-repeat object 210. As suggested above, and as will be discussed further below, however, the radial-repeat alignment system 106 aligns the outer radii or the middle radii in some implementations. Further, in some cases, the radial-repeat alignment system aligns an inner radius with an outer radius, aligns an outer radius with an inner radius, or aligns a middle radius with an inner or outer radius.

In one or more embodiments, the radial-repeat alignment system 106 aligns the first radial-repeat object 208 and the second radial-repeat object 210 by modifying at least one of the first radial-repeat object 208 or the second radial-repeat object 210. In particular, in some cases, the radial-repeat alignment system 106 modifies a radius of at least one of the first radial-repeat object 208 or the second radial-repeat object 210 (e.g., decreases the radius of the first radial-repeat object 208 or increases the radius of the second radial-repeat object 210).

It should be understood that, in some instances, modifying a radius of a radial-repeat object more generally involves modifying the distance between the center point of the radial-repeat object and another point of the radial-repeat object. For instance, in some embodiments, modifying a radius of a radial-repeat object includes repositioning its object instances farther away from or closer to its center point, thus modifying the distance between the center point and the other point of the radial-repeat object (whether the other point is positioned within or outside of one of the object instances). Thus, in some embodiments, discussion of modifying a radius of a radial-repeat object more generally involves modifying the various distinguishable radii of the radial-repeat object (e.g., the inner radius, the outer radius, and/or the middle radii) as the boundaries of the radial-repeat object are changed. In some cases, however, modifying a radius of a radial-repeat object more specifically includes modifying a particular radius (e.g., the inner or outer radius). For instance, in some cases, modifying a radius of a radial-repeat object includes stretching its object instances towards or away from its center point. Thus, in such embodiments, the radial-repeat alignment system 106 changes one boundary of the radial-repeat object (and its corresponding radius) while maintaining the other boundary (and its corresponding radius).

To illustrate, in some cases, the radial-repeat alignment system 106 detects user input for modifying a radius of the first radial-repeat object 208 (e.g., user input dragging a widget or other interactive element that changes the radius of the first radial-repeat object 208). In response to the user input (e.g., as the user input drags the widget to change the radius), the radial-repeat alignment system 106 modifies the radius of the first radial-repeat object 208 to facilitate the alignment. For instance, in some implementations, the radial-repeat alignment system 106 snaps the object instances of the first radial-repeat object 208 to positions that aligns the radius of the first radial-repeat object 208 with the corresponding radius of the second radial-repeat object 210 (e.g., aligns their inner radii). In some cases, the radial-repeat alignment system 106 snaps the objects instances upon determining that the user input positions the radius of the first radial-repeat object 208 within a threshold number of pixels of the radius of the second radial-repeat object 210.

As further shown in FIG. 2, the radial-repeat alignment system 106 generates and provides, for display within the digital design 202, a visual guide 214 that indicates the alignment of the first radial-repeat object 208 and the second radial-repeat object 210. In particular, the visual guide 214 indicates the alignment of a radius of the first radial-repeat object 208 with a radius of the second radial-repeat object 210 (e.g., their inner radii).

Indeed, while modifying a radius of a radial-repeat object generally refers to changing the distance between its center point and another point in some instances, aligning the radii of radial-repeat objects more specifically involves the alignment of particular radii in some implementations. For instance, as mentioned, FIG. 2 illustrates the alignment of the inner radius of the first radial-repeat object 208 with the inner radius of the second radial-repeat object 210. As further mentioned, the radial-repeat alignment system 106 aligns the outer radii or the middle radii of radial-repeat objects. Thus, in some instances, aligning radii of radial-repeat objects involves aligning a particular radius of one radial-repeat object with the corresponding radius of another radial-repeat object. It should be understood, however, that the radial-repeat alignment system 106 aligns various combinations of radii in various embodiments (e.g., aligns the inner radius of one radial-repeat object with the out radius of another radial-repeat object).

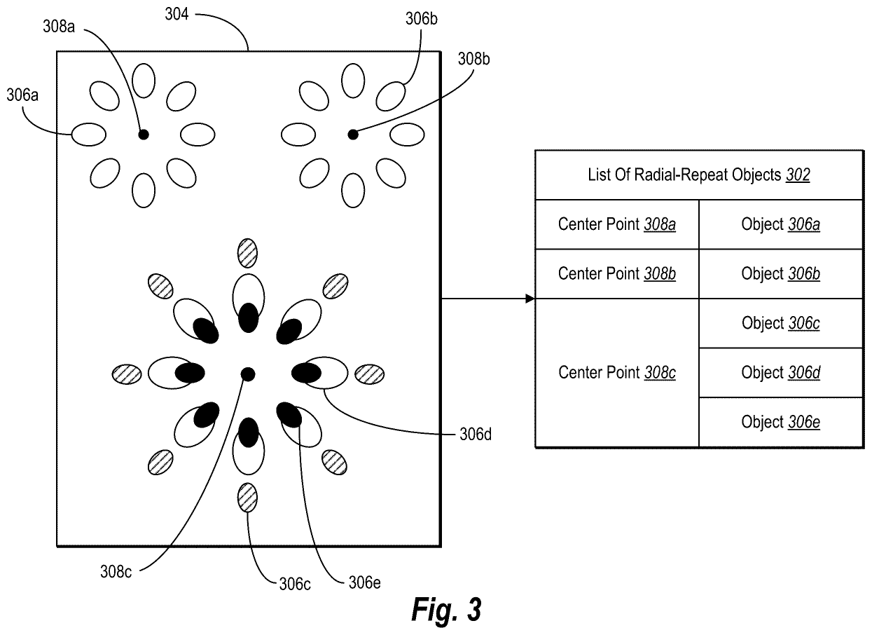

As previously mentioned, in one or more embodiments, the radial-repeat alignment system 106 generates a list of the radial-repeat objects portrayed within a digital design. FIG. 3 illustrates the radial-repeat alignment system 106 generating a list of radial-repeat objects for a digital design in accordance with one or more embodiments.

Indeed, as shown in FIG. 3, the radial-repeat alignment system 106 generates a list 302 of radial-repeat objects for a digital design 304. In one or more embodiments, the radial-repeat alignment system 106 generates the list 302 upon accessing the digital design 304. For instance, in some embodiments, the radial-repeat alignment system 106 generates the list 302 upon determining that a client application (e.g., a client application implementing or accessing the radial-repeat alignment system 106) has opened the digital design 304. In some implementations, the radial-repeat alignment system 106 generates the list 302 upon determining that a slot in the background task executor is available after opening the digital design 304 to avoid creating a negative impact on the document open operation or other user operation.

As shown in FIG. 3, the digital design 304 portrays radial-repeat objects 306a-306e. The radial-repeat objects 306a-306b are isolated in that they are each associated with a unique center point that is not associated with any other radial-repeat object of the digital design 304. In particular, the radial-repeat object 306a is associated with center point 308a, and the radial-repeat object 306b is associated with center point 308b. The radial-repeat objects 306c-306e, however, are concentric in that they share a center point. Indeed, as shown, the radial-repeat objects 306c-306e are each associated with the center point 308c.

As further shown in FIG. 3, the radial-repeat alignment system 106 generates the list 302 of radial-repeat objects by generating a light database of information regarding the radial-repeat objects 306a-306e. In particular, the list 302 of radial-repeat objects includes a mapping of each radial-repeat object within the digital design 304 to its corresponding center point. For instance, as shown, the list 302 maps the radial-repeat object 306a to the center point 308a and maps the radial-repeat object 306b to the center point 308b. Thus, the mapping of the list 302 indicates that each of the radial-repeat objects 306a-306b are isolated in that they do not share a center point with any other radial-repeat object portrayed in the digital design 304. As further shown, the list 302 maps each of the radial-repeat objects 306c-306e to the center point 308c. Thus, the mapping of the list 302 indicates that the radial-repeat objects 306c-306e are concentric in that they share the center point 308c.

In one or more embodiments, the radial-repeat alignment system 106 dynamically updates the list 302 as the digital design 304 is modified. In particular, the radial-repeat alignment system 106 updates based on changes made to the radial-repeat objects portrayed within the digital design 304. For instance, in some embodiments, upon determining that a new radial-repeat object has been added to the digital design 304, the radial-repeat alignment system 106 adds a new entry into the list 302 that maps the new radial-repeat object to its corresponding center point (whether its center point is unique or shared with one of the other radial-repeat objects). In some cases, upon determining that one of the radial-repeat objects 306a-306e has been removed from the digital design 304, the radial-repeat alignment system 106 deletes the corresponding entry from the list 302. Further, in some instances, upon determining that one of the radial-repeat objects 306a-306e has been moved so that its center point has changed, the radial-repeat alignment system 106 modifies the list 302 to map the moved radial-repeat object to its new center point (whether its center point is unique or shared with one of the other radial-repeat objects). Thus, the radial-repeat alignment system 106 uses the list 302 to maintain an up-to-date record of the radial-repeat objects and their associated center points.

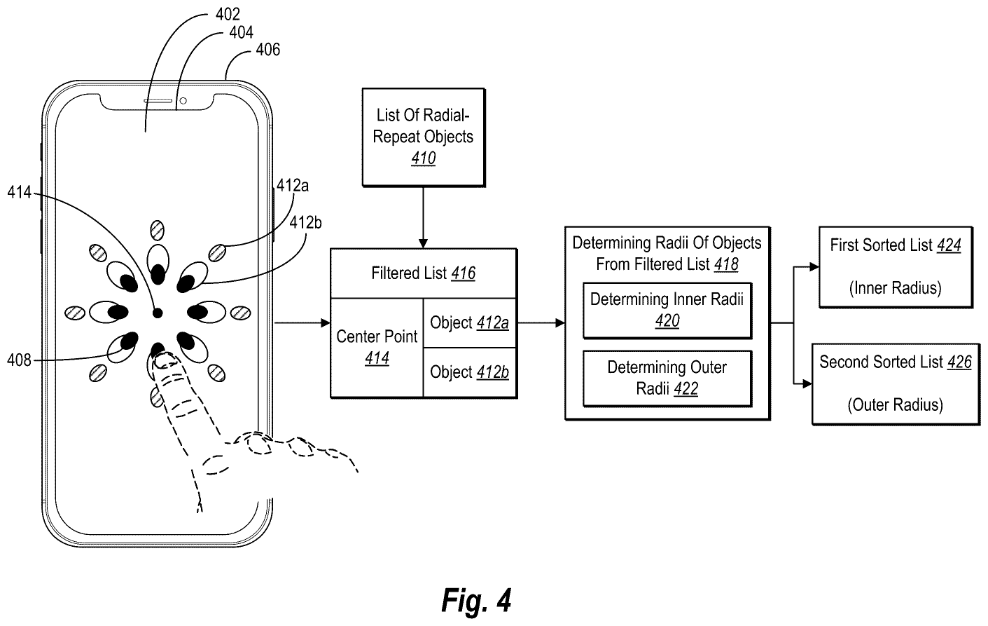

As further mentioned above, in one or more embodiments, the radial-repeat alignment system 106 filters and sorts the list of radial-repeat objects generated for a digital design in response to user input. FIG. 4 illustrates the radial-repeat alignment system 106 filtering and sorting a list of radial-repeat objects generated for a digital design in accordance with one or more embodiments.

Indeed, as shown, the radial-repeat alignment system 106 detects, via a graphical user interface 404 of a client device 406, a user interaction targeting a radial-repeat object 408 portrayed within a digital design 402. In one or more embodiments the digital design 402 corresponds to the digital design 304 illustrated in FIG. 3. In particular, in some cases, FIG. 4 illustrates a portion of the digital design 402 (e.g., a zoomed-in portion) displayed within the graphical user interface 404.

In some embodiments, the user interaction includes a selection of the radial-repeat object 408. Additionally, or alternatively, the user interaction includes an interaction for modifying the radial-repeat object 408, such as through a modification of a radius of the radial-repeat object 408. For instance, in some cases, the user interaction includes an interaction with a widget associated with the radial-repeat object 408 or the radial-repeat object 408 itself (e.g., an object instance of the radial-repeat object 408) to increase or decrease a radius of the radial-repeat object 408. For instance, in some cases, the user interaction includes an interaction for moving the widget or the radial-repeat object 408 itself (e.g., a dragging motion) to increase or decrease the radius.

As further shown in FIG. 4, the radial-repeat alignment system 106 accesses a list 410 of radial-repeat objects generated for the digital design 402. In one or more embodiments, the list 410 maps the radial-repeat objects portrayed within the digital design 402 to their corresponding center points. Thus, as discussed above with reference to FIG. 3, in some embodiments, the list 410 indicates that the radial-repeat object 408 targeted by the user interaction is concentric with the radial-repeat objects 412a-412b as the mapping of the list 410 indicates that the radial-repeat object 408 shares a center point 414 with the radial-repeat objects 412a-412b.

As shown in FIG. 4, in response to detecting the user interaction with the radial-repeat object 408, the radial-repeat alignment system 106 generates a filtered list 416 from the list 410 of radial-repeat objects. As shown, the filtered list 416 includes those radial-repeat objects within the digital design 402 (i.e., the radial-repeat objects 412a-412b) that are concentric with the radial-repeat object 408. Indeed, in one or more embodiments, the radial-repeat alignment system 106 creates the filtered list 416 from the list 410 of radial-repeat objects by filtering out those entries for radial-repeat objects that are not concentric with the radial-repeat object 408.

In some embodiments, the radial-repeat alignment system 106 further creates the filtered list 416 by filtering out, from the list 410, entries for radial-repeat objects that have had their visibility turned off (e.g., via user input) or entries for radial-repeat objects that are at least partially outside of the current display area. Indeed, as previously suggested, in some cases, the digital design 402 includes other radial-repeat objects that are not currently displayed within the graphical user interface 404. For example, in some instances, FIG. 4 illustrates a zoomed-in portion of the digital design 402. As such, in some embodiments, the radial-repeat alignment system 106 omits those radial-repeat objects outside the current display area from the filtered list 416.

As shown in FIG. 4, the radial-repeat alignment system 106 further performs an act 418 of determining radii of the radial-repeat objects 412a-412b from the filtered list 416. In particular, as shown, the radial-repeat alignment system 106 performs the act 418 by performing an act 420 of determining the inner radii of the radial-repeat objects and an act 422 of determining the outer radii of the radial-repeat objects. In some embodiments, the radial-repeat alignment system 106 additionally or alternatively determines one or more middle radii for each of the radial-repeat objects. For instance, in some cases, the radial-repeat alignment system 106 selects a point within each of the radial-repeat objects from the filtered list 416 and determines a middle radius based on that point. Further, in some cases, the radial-repeat alignment system 106 determines a single radius for each radial-repeat object, such as by determining an inner radius, a middle radius, or an outer radius. Determining radii for a radial-repeat object will be discussed further below.

Though FIG. 4 illustrates the radial-repeat alignment system 106 determining the radii of the 412a-412b after determining that the radial-repeat object 408 has been targeted by a user interaction, the radial-repeat alignment system 106 can determine the radii at various points in various embodiments. For instance, in some implementations, the radial-repeat alignment system 106 determines the radii of all radial-repeat objects present within the digital design 402 when the list 410 of radial-repeat objects is created and stores the radii as part of the list 410. In some embodiments, the radial-repeat alignment system 106 determines the radii as soon as the digital design 402 is opened. In some cases, the radial-repeat alignment system 106 determines the radii upon determining that computing resources are available for performing the act 418.

As further shown in FIG. 4, the radial-repeat alignment system 106 sorts the filtered list 416 based on the determined radii for the radial-repeat object 412a-412b represented therein. In particular, the radial-repeat alignment system 106 generates a copy of the filtered list 416 and then sorts the two copies to generates a first sorted list 424 and a second sorted list 426. As illustrated in FIG. 4, the radial-repeat alignment system 106 generates the first sorted list 424 by sorting the radial-repeat objects 412a-412b based on their inner radius (e.g., in ascending or descending order) Further, the radial-repeat alignment system 106 generates the second sorted list 426 by sorting the radial-repeat objects 412a-412b based on their outer radius (e.g., in ascending or descending order).

In one or more embodiments, when generating a sorted list, the radial-repeat alignment system 106 further considers the z-ordering of the radial-repeat objects. For instance, where two or more radial-repeat objects have the same radius (e.g., the same inner radius or outer radius), the radial-repeat alignment system 106 sorts those radial-repeat objects based on their z-order. For example, in at least one implementation, the radial-repeat alignment system 106 assigns the radial-repeat object that is on top in the z-order with a higher ranking within the sorted list (e.g., where the radial-repeat objects are sorted in ascending order).

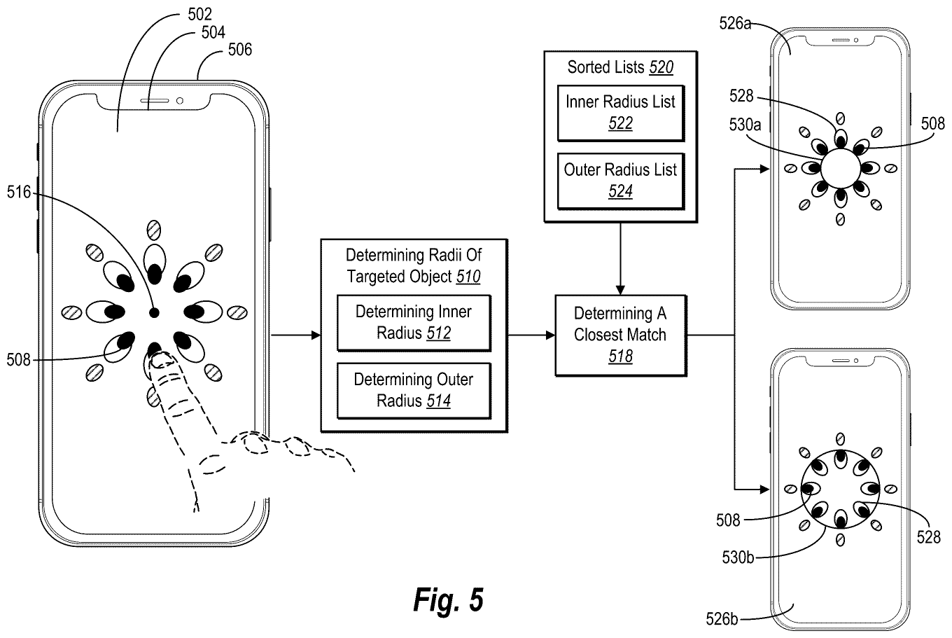

As mentioned above, in one or more embodiments, the radial-repeat alignment system 106 uses the sorted lists to facilitate the alignment of a radial-repeat object targeted by a user interaction with another radial-repeat object portrayed within the digital design. In particular, the radial-repeat alignment system 106 uses the sorted lists to align the targeted radial-repeat object with a concentric radial-repeat object. FIG. 5 illustrates the radial-repeat alignment system 106 using sorted lists to align a targeted radial-repeat object with another radial-repeat object in accordance with one or more embodiments.

As shown in FIG. 5, the radial-repeat alignment system 106 detects, via a graphical user interface 504 of a client device 506, a user interaction targeting a radial-repeat object 508 portrayed within a digital design 502. In some instances, the digital design 502 corresponds to the digital design 402 discussed with respect to FIG. 4.

As further shown, in response to the user interaction, the radial-repeat alignment system 106 performs an act 510 of determining radii for the radial-repeat object 508 targeted by the user interaction. In particular, the radial-repeat alignment system 106 performs the act 510 by performing an act 512 of determining the inner radius of the radial-repeat object 508 and an act 514 of determining an outer radius of the radial-repeat object 508. How the radial-repeat alignment system 106 determines the radii of a radial-repeat object will be discussed further below.

In one or more embodiments, the radial-repeat alignment system 106 determines the radii of the radial-repeat object 508 as the radii change due to the user interaction. For instance, in some cases, based on the user interaction, the radial-repeat alignment system 106 increases or decreases the radii of the radial-repeat object 508 (e.g., moves its object instances farther away from or close to the center point 516). For example, as previously discussed, in some implementations, the user interaction interacts with a widget associated with the radial-repeat object 508 or the object instances of the radial-repeat object 508 themselves to increase or decrease its radii. Accordingly, in some cases, the radial-repeat alignment system 106 updates its determination of the radii of the radial-repeat object 508 as they change.

As further shown in FIG. 5, the radial-repeat alignment system 106 further performs an act 518 of determining a closest match for the radial-repeat object 508. In particular, the radial-repeat alignment system 106 identifies a radial-repeat object that is a closest match to the inner radius or the outer radius determined for the radial-repeat object 508. In one or more embodiments, the radial-repeat alignment system 106 determines that a radial-repeat object is a closest match to the radial-repeat object 508 based on determining that the radial-repeat object has a radius that is closer to a radius of the radial-repeat object 508 than the radii of other radial-repeat objects.

As shown, the radial-repeat alignment system 106 uses the sorted lists 520 previously determined for the digital design 502 based on the radial-repeat object 508 being targeted by the user interaction to determine the closest match. For example, in one or more embodiments, the radial-repeat alignment system 106 uses the list 522 of radial-repeat objects sorted based on inner radius to identify a radial-repeat object represented therein having an inner radius that is closest to the inner radius of the radial-repeat object 508. Similarly, in one or more embodiments, the radial-repeat alignment system 106 uses the list 524 of radial-repeat objects sorted based on outer radius to identity a radial-repeat object represented therein having an outer radius that is closest to the outer radius of the radial-repeat object 508. For instance, in some embodiments, the radial-repeat alignment system 106 performs a binary search on each of the sorted lists 520 to identify a radial-repeat object that is a closest match from each list. In some cases, the radial-repeat alignment system 106 further compares the two radial-repeat objects identified from the sorted lists 520 to determine an overall closest matching radial-repeat object.

In one or more embodiments, the radial-repeat alignment system 106 changes its determination of the closest matching radial-repeat object based on changes to the radial-repeat object 508. For instance, in some embodiments, the radial-repeat alignment system 106 uses the sorted lists 520 to identify a first radial-repeat object as a closest match with the radial-repeat object 508 based on the current radii of the radial-repeat object 508. In some cases, however, as the user interaction continues to change the radii of the radial-repeat object 508, the radial-repeat alignment system 106 determines that the first radial-repeat object is no longer the closest match. In other words, the radial-repeat alignment system 106 determines that a second radial-repeat object is now the closest match to the radial-repeat object 508. Thus, the radial-repeat alignment system 106 dynamically updates its determination of the closest matching radial-repeat object based on changes to the radii of the radial-repeat object 508 caused by user interactions.

In one or more embodiments, the radial-repeat alignment system 106 determines a closest match based on pixel distances. For example, in some cases, the radial-repeat alignment system 106 measures the radii of radial-repeat objects in number of pixels. Thus, the radial-repeat alignment system 106 determines the difference between the radii of different radial-repeat objects based on the difference in the pixel distances of the radii. Thus, in some cases, the radial-repeat alignment system 106 determines that a radial-repeat object is a closest match based on determining that the difference in pixel distance between a radius of the radial-repeat object and a radius of the radial-repeat object 508 is smaller than the differences in pixel distance between the radii of the other radial-repeat objects and the radii of the radial-repeat object 508.

In one or more embodiments, the radial-repeat alignment system 106 selects the radial-repeat object identified as the closest match for use in modifying the radius of the radial-repeat object 508. In particular, in some embodiments, the radial-repeat alignment system 106 modifies the radial-repeat object 508 to align a radius of the radial-repeat object 508 (e.g., an inner, middle, or outer radius) with a radius of the radial-repeat object identified as the closest match (e.g., the inner, middle, or outer radius of the identified radial-repeat object).

In some embodiments, the radial-repeat alignment system 106 uses a threshold number of pixels in selecting a radial-repeat object for alignment with the radial-repeat object 508. For instance, in some cases, despite a radial-repeat object being identified as a closest match, the radial-repeat alignment system 106 waits until a radius of the radial-repeat object 508 comes within a threshold number of pixels of a radius of the identified radial-repeat object before selecting the identified radial-repeat for alignment with the radial-repeat object 508. In particular, in some instances, the radial-repeat alignment system 106 waits until the user interaction targeting the radial-repeat object 508 has caused a radius of the radial-repeat object 508 to come within a threshold number of pixels of a radius of the closest matching radial-repeat object before selecting the closest matching radial-repeat object for alignment with the radial-repeat object 508.

In some implementations, the radial-repeat alignment system 106 waits until the corresponding radii of the radial-repeat object 508 and the closest matching radial-repeat object come within the threshold number of pixels before selecting the closest matching radial-repeat object for alignment. To illustrate, in some instance, the radial-repeat alignment system 106 waits until the inner radius of the radial-repeat object 508 comes within a threshold number of pixels of the inner radius of the closest matching radial-repeat object before selecting the closest matching radial-repeat object for alignment with the radial-repeat object 508. Additionally, or alternatively, the radial-repeat alignment system 106 waits until the outer radius of the radial-repeat object 508 comes within the threshold number of pixels of the outer radius of the closest matching radial-repeat object before selecting the closest matching radial-repeat object for alignment.

In one or more embodiments, the radial-repeat alignment system 106 establishes the threshold number of pixels based on user input. For instance, in some cases, the radial-repeat alignment system 106 receives user input via the client device 506 that defines the threshold number of pixels. In some embodiments, the radial-repeat alignment system 106 defines the threshold number of pixels (e.g., as a default). In some instances, the radial-repeat alignment system 106 uses the same threshold number of pixels for all radii. In some implementations, however, the radial-repeat alignment system 106 establishes a separate threshold number of pixels for each radius (e.g., a first threshold for the inner radii of radial-repeat objects and a second threshold for the outer radii of radial-repeat objects).

As further shown in FIG. 5, the radial-repeat alignment system 106 modifies the radial-repeat object 508 to align a radius of the radial-repeat object 508 with a radius of a closest matching radial-repeat object identified using the sorted lists 520. In particular, FIG. 5 illustrates modified digital designs 526a-526b as possible results of the radial-repeat alignment system 106 aligning the radial-repeat object 508 with a radial-repeat object 528 identified as a closest matching radial-repeat object using one or more of the sorted lists 520. In particular, the radial-repeat alignment system 106 generates the modified digital design 526a when aligning the inner radius of the radial-repeat object 508 with the inner radius of the radial-repeat object 528. Alternatively, the radial-repeat alignment system 106 generates the modified digital design 526b when aligning the outer radius of the radial-repeat object 508 with the outer radius of the radial-repeat object 528.

In one or more embodiments, the radial-repeat alignment system 106 generates the modified digital design 526a or the modified digital design 526b based on radii of the radial-repeat object 508. Indeed, as mentioned, the user interaction with the radial-repeat object 508 causes the radii to increase or decrease in some embodiments. Thus, in some cases, the radial-repeat alignment system 106 monitors changes to the radii of the radial-repeat object 508 to determine how to align the radial-repeat object 508 with another radial-repeat object. For instance, if changes to the radii of the radial-repeat object 508 causes a closer match between the inner radii of the radial-repeat object 508 and the radial-repeat object 528 than the outer radii, then the radial-repeat alignment system 106 generates the modified digital design 526a by aligning the inner radii. In contrast, if changes to the radii of the radial-repeat object 508 causes a closer match between the outer radii of the radial-repeat object 508 and the radial-repeat object 528 than the inner radii, the radial-repeat alignment system 106 generates the modified digital design 526b by aligning the outer radii.

Though FIG. 5 illustrates the radial-repeat object 528 having the closest matching inner and outer radius, it should be understood that different radial-repeat objects can be identified from the sorted lists 520 as the closest match in various embodiments. Indeed, in some instances, the radial-repeat alignment system 106 identifies one radial-repeat object as having the closest matching inner radius and identifies another radial-repeat object as having the closest matching outer radius. Thus, in some implementations and based on the radii of the radial-repeat object 508, the radial-repeat alignment system 106 modifies the digital design 502 to align the radial-repeat object 508 with the radial-repeat object identified as having the closest matching inner radius (e.g., to align their inner radii) or modifies the digital design 502 to align the radial-repeat object 508 with the radial-repeat object identified as having the closest matching outer radius (e.g., to align their outer radii).

Thus, in one or more embodiments, the radial-repeat alignment system 106 uses the sorted lists 520 to identify at least one closest matching radial-repeat object for the radial-repeat object 508—such as by identifying one radial-repeat object from the list 522 sorted based on inner radius and one radial-repeat object from the list 524 sorted based on outer radius (e.g., where the same or different radial-repeat objects can be identified as the closest matching from each list). In some cases, the radial-repeat alignment system 106 updates the determination based on changes made to the radii of the radial-repeat object 508 in response to the user interaction. In some embodiments, the radial-repeat alignment system 106 further modifies the digital design 502 by aligning the radial-repeat object 508 with one of the closest matching radial-repeat objects identified from the sorted lists 520. In particular, in some cases, the radial-repeat alignment system 106 aligns the inner radius of the radial-repeat object 508 with the inner radius of the radial-repeat object identified from the list 522 sorted based on inner radius. Alternatively, in some instances, the radial-repeat alignment system 106 aligns the outer radius of the radial-repeat object 508 with the outer radius of the radial-repeat object identified from the list 524 sorted based on outer radius. In some cases, the radial-repeat alignment system 106 determines to align the inner radii or the outer radii based on determining that the inner radii or the outer radii are a closer match, respectively.

In one or more embodiments, the radial-repeat alignment system 106 aligns the radial-repeat object 508 with the radial-repeat object 528 via a snapping operation. For example, in some cases, upon determining that the user interaction has moved the inner radius of the radial-repeat object 508 within a threshold number of pixels of the inner radius of the radial-repeat object 528, the radial-repeat alignment system 106 snaps the radial-repeat object 508 so that the inner radii are aligned. In other words, the radial-repeat alignment system 106 modifies the radial-repeat object 508 via a snapping operation to align the inner radii. Similarly, upon determining that the user interaction has moved the outer radius of the radial-repeat object 508 within the threshold number of pixels of the outer radius of the radial-repeat object 528, the radial-repeat alignment system 106 snaps the radial-repeat object 508 so that the outer radii are aligned. In other words, the radial-repeat alignment system 106 modifies the radial-repeat object 508 via a snapping operation to align the outer radii.

Indeed, in some cases, the radial-repeat alignment system 106 waits until the user interaction moves a radius (e.g., an inner radius or outer radius) of the radial-repeat object 508 within a threshold number of pixels of a corresponding radius (e.g., the inner radius or outer radius, respectively) of the radial-repeat object 528. Upon determining that the radii are within a threshold number of pixels, the radial-repeat alignment system 106 automatically snaps the radial-repeat object 508 to be aligned with the radial-repeat object 528. In other words, the radial-repeat alignment system 106 momentarily assumes control of modifying the radial-repeat object 508 and automatically adjusts the radius of the radial-repeat object 508 (e.g., the inner radius or outer radius) to align with the corresponding radius (e.g., the inner radius or outer radius, respectively) of the radial-repeat object 528.

As further shown in FIG. 5, the radial-repeat alignment system 106 generates and provides a visual guide indicating the alignment between the radial-repeat object 508 and the radial-repeat object 528. For example, FIG. 5 illustrates the radial-repeat alignment system 106 generating and providing the visual guide 530a for display within the modified digital design 526a to indicate that the inner radii of the radial-repeat object 508 and the radial-repeat object 528 have been aligned. Similarly, FIG. 5 illustrates the radial-repeat alignment system 106 generating and providing the visual guide 530b for display within the modified digital design 526b to indicate that the outer radii of the radial-repeat object 508 and the radial-repeat object 528 have been aligned.

FIG. 5 illustrates the visual guides 530a-530b as circles highlighting the aligned radii (e.g., highlighting the circumference obtained due to aligning the radii). The radial-repeat alignment system 106, however, uses various visual guides in various embodiments. For example, in some cases, the radial-repeat alignment system 106 uses an alternative visual element, such as a text box providing a message indicating the alignment or a visual highlighting of the radial-repeat object 508 and/or the radial-repeat object 528 (e.g., a visual highlighting of their respective object instances). In some cases, the radial-repeat alignment system 106 provides an audio cue to convey that the radial-repeat object 508 and the radial-repeat object 528 have been aligned.

In one or more embodiments, the radial-repeat alignment system 106 removes the visual guide upon determining that further user input has moved the radial-repeat object 508 or the radial-repeat object 528 sufficiently to move the aligned radii outside of the threshold number of pixels. To illustrate, in some cases, the radial-repeat alignment system 106 detects further user interaction modifying the radial-repeat object 508 so that the inner radius of the radial-repeat object 508 moves away from the inner radius of the radial-repeat object 528 sufficiently enough so that the radii are outside the threshold number of pixels. Accordingly, the radial-repeat alignment system 106 removes the visual guide 530a to indicate that the inner radii are no longer aligned.

In some cases, once the inner radii of the radial-repeat object 508 and the radial-repeat object 528 are aligned, the radial-repeat alignment system 106 maintains the alignment until the user interaction indicates sufficient movement to cause the distance between the inner radii to be larger than the threshold number of pixels. Similarly, once the outer radii of the radial-repeat object 508 and the radial-repeat object 528 are aligned, the radial-repeat alignment system 106 maintains the alignment until the user interaction indicates sufficient movement to cause the distance between the outer radii to be larger than the threshold number of pixels. Accordingly, in some embodiments, upon determining the user interaction indicates sufficient movement to cause the distance between aligned radii to be larger than the threshold number of pixels, the radial-repeat alignment system 106 adjusts the radii of the targeted radial-repeat object and removes the visual guide to indicate that the radial-repeat objects are no longer aligned.

Thus, the radial-repeat alignment system 106 operates more flexibly when compared to conventional systems. Indeed, the radial-repeat alignment system 106 offers a flexible feature for automatically aligning the radii of different radial-repeat objects within a digital design. In particular, the radial-repeat alignment system 106 detects a user interaction for modifying one of the radial-repeat objects and flexibly performs various acts to align the targeted radial-repeat object with another radial-repeat object by aligning their inner radii, their outer radii, or other radii. By automating the alignment process, the radial-repeat alignment system 106 further offers improved efficiency when compared to conventional systems. In particular, the radial-repeat alignment system 106 reduces the number of user interactions typically required under conventional systems by detecting the user interaction and automatically performing the alignment in response with various behind-the-scenes operations. Further, the radial-repeat alignment system 106 offers improved accuracy by more accurately positioning a radial-repeat object within the digital design to align one of its radii with the radius of another radial-repeat object. Indeed, by automating the alignment process, the radial-repeat alignment system 106 avoids the user error that typically plagues conventional systems and provides precision alignments.

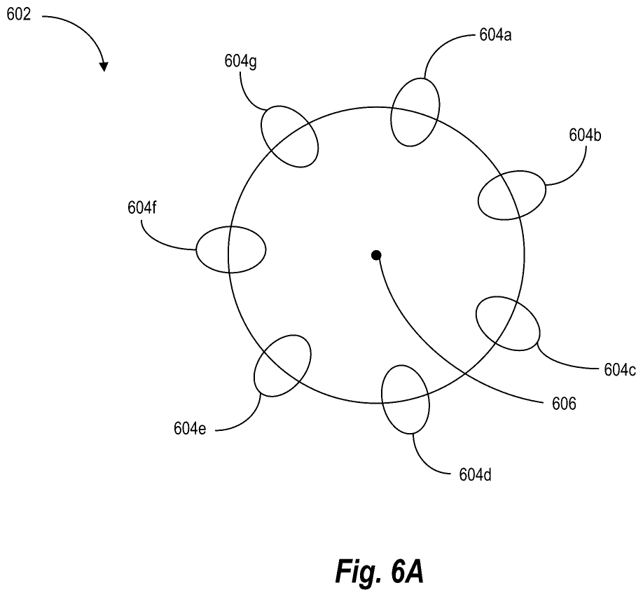

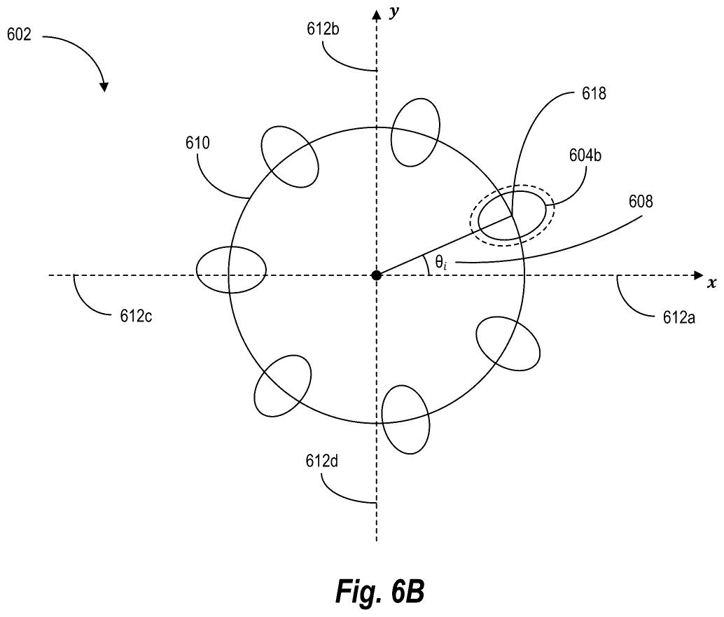

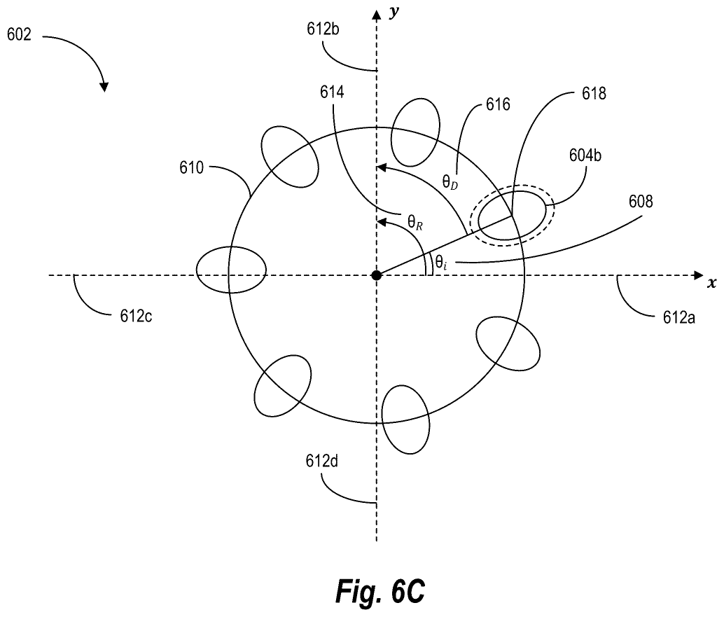

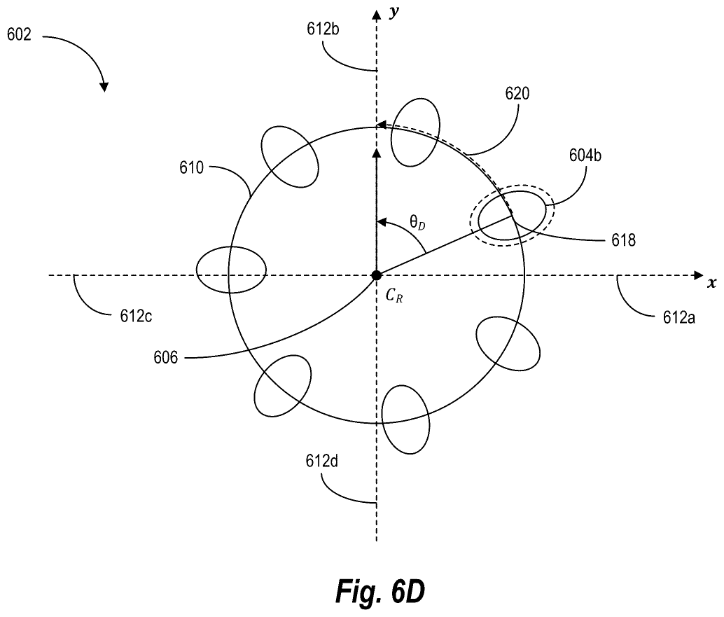

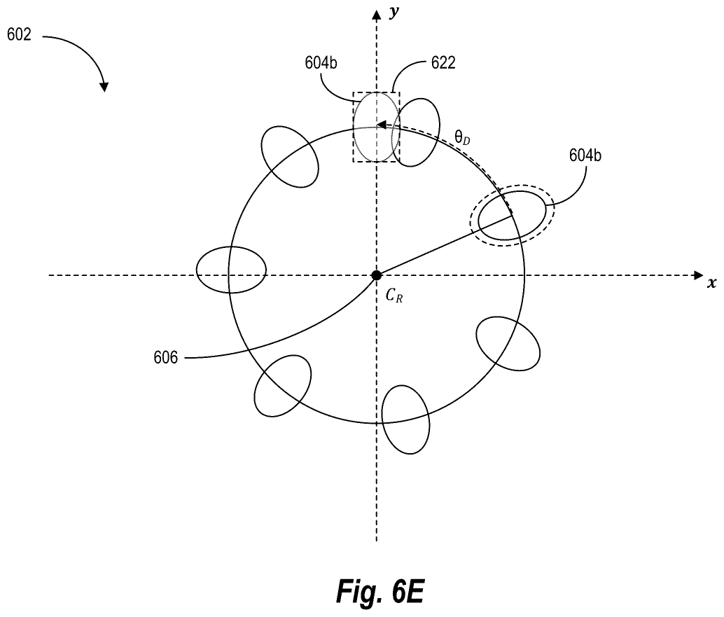

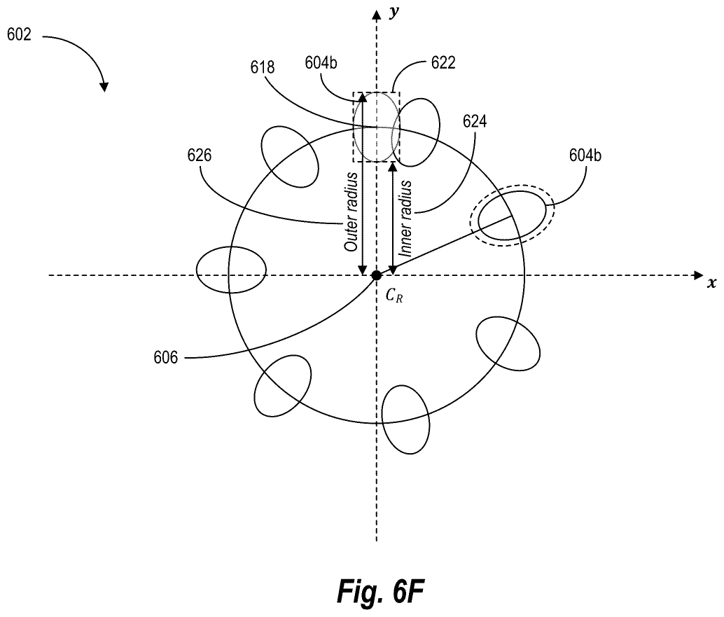

As mentioned, in one or more embodiments, the radial-repeat alignment system 106 determines (e.g., extracts) the radii of a radial-repeat object. For instance, the radial-repeat alignment system 106 determines the radii of a radial-repeat object that is targeted by one or more user interactions. Further, the radial-repeat alignment system 106 determines the radii of one or more radial-repeat objects considered for alignment with the radial-repeat object targeted by the user interaction(s). FIGS. 6A-6F illustrate the radial-repeat alignment system 106 determining the radii of a radial-repeat object in accordance with one or more embodiments.

In one or more embodiments, the radial-repeat alignment system 106 implements a generalized approach that facilitates determining the radii of a radial-repeat object regardless of its configuration. In particular, some radial-repeat object configurations present technical challenges in determining the desired radii. For instance, a configuration in which the radial-repeat object contains no object instance at a position directly above its center point or a configuration in which the object instances of the radial-repeat object are in a rotated state can create difficulties in determining their radii. In some cases, an unrotated state of an object instance includes a state in which the bounding box of the object instance is vertically oriented or horizontally oriented so the closest point of the bounding box to the center point of the radial-repeat object is also the closest point of the object instance to the center point. Thus, in some implementations, a rotated state of an object instance includes a state in which the object instance has been rotated away from the unrotated state. In some instances, an unrotated state of an object instance includes its default state-its orientation when the radial-repeat object is initially added to the digital design (e.g., its initial orientation with respect to the center point of the radial-repeat object).

To illustrate, in some cases, it is desirable to use the bounding box of an object instance to determine the inner and outer radii of a radial-repeat object. For instance, it may be desirable to use the closest distance between the bounding box and the center point of the radial-repeat object as the inner radius or to use the farthest distance between the bounding box and the center point as the outer radius of the radial-repeat object. When a radial-repeat object, however, includes a configuration where the object instances are rotated and/or positioned away from the location directly above its center point, determining the radii using the bounding box of one of the object instances becomes ambiguous. Accordingly, in one or more embodiments, the radial-repeat alignment system 106 implements a flexible approach that facilitates the determination of the radii of a radial-repeat object regardless of its configuration. In particular, in some embodiments, the radial-repeat alignment system 106 uses an approach for logically modifying an object instance of a radial-repeat object and appropriating its bounds for use in determining the radii.

In one or more embodiments, the radial-repeat alignment system 106 implements the approach by performing various logical operations on the radial-repeat object. In one or more embodiments, the radial-repeat alignment system 106 performs a logical operation by theoretically or effectively performing an operation without actually performing the operation. For instance, in some cases, the radial-repeat alignment system 106 performs a logical operation on the radial-repeat object by theoretically or effectively modifying the radial-repeat object without actually modifying the radial-repeat object. In other words, the radial-repeat alignment system 106 determines how the radial-repeat object would change if a modification were applied to the radial-repeat object without actually applying the modification.

To illustrate and as will be explained in more detail below, in one or more embodiments, the radial-repeat alignment system 106 logically translates the radial-repeat object from its initial position to an origin of the digital design. For example, in some cases, the radial-repeat alignment system 106 logically translates the radial-repeat object so that its central point is logically positioned at the origin of the digital design. The radial-repeat alignment system 106 further logically rotates an object instance of the radial-repeat object to an upright position directly above its center point while the radial-repeat object is at the origin of the digital design. Thus, in some cases, if the object instance is initially located at a position other than the position directly above the center point and/or is in a rotated state, the radial-repeat alignment system 106 adjusts the object instance so that it is directly above the center point of the radial-repeat object and in an unrotated state. Additionally, while the object instance is logically rotated to the upright position directly above the center point, the radial-repeat alignment system 106 logically translates the radial-repeat object back to its initial position. Thus, in some cases, the radial-repeat alignment system 106 determines the radii of the radial-repeat object at its initial position with the object instance logically at the upright position directly above the center point of the radial-repeat object.

For instance, FIG. 6A illustrates a radial-repeat object 602 portrayed within a digital design. The radial-repeat object 602 includes object instances 604a-604g. As shown, none of the object instances 604a-604g are located at a position directly above the center point 606 of the radial-repeat object 602. Indeed, while the object instance 604a is positioned near the top of the radial-repeat object 602, the object instance 604a is not located directly above the center point 606. Accordingly, the radial-repeat object 602 has a configuration that may cause difficulty in determining its radii. By implementing the generalized approach described herein, however, the radial-repeat alignment system 106 extracts the radii from the radial-repeat object 602.

As shown in FIG. 6B, the radial-repeat alignment system 106 selects an object instance for use in determining the radii of the radial-repeat object 602. In particular, FIG. 6B shows the radial-repeat alignment system 106 selecting the object instance 604b for use in determining the radii. The radial-repeat alignment system 106, however, uses various object instances in various embodiments. Indeed, in some cases, the approach implemented by the radial-repeat alignment system 106 facilitates determination of radii regardless of the object instance selected.

As further shown in FIG. 6B, the radial-repeat alignment system 106 determines an angular position 608 (represented as θᵢ) for the object instance 604b along the circle 610. In particular, as shown, the radial-repeat alignment system 106 determines the angular position 608 with respect to a central point 618 of the object instance 604b.

Indeed, as shown, the radial-repeat alignment system 106 uses the circle 610, the y-axis, and/or the x-axis to determine the angular position 608 for the object instance 604b. To illustrate, in some cases, the radial-repeat alignment system 106 establishes a coordinate scheme using the y-axis and the x-axis and represented by the circle 610. In some cases, based on the coordinate scheme established, the degrees used by the radial-repeat alignment system 106 increases in a counter-clockwise direction beginning at the positive x-axis 612a. For instance, in some embodiments, the radial-repeat alignment system 106 associates the positive x-axis 612a with zero degrees, the positive y-axis 612b with ninety degrees, the negative x-axis 612c with one hundred eighty degrees, and the negative y-axis 612d with two hundred seventy degrees. As such, in some implementations, the radial-repeat alignment system 106 determines the angular position 608 for the object instance 604b based on its angular position from the positive x-axis 612a.

The radial-repeat alignment system 106 establishes different coordinate schemes in various embodiments. For instance, the radial-repeat alignment system 106 establishes that the degrees increase in a clockwise direction and/or begins with the positive y-axis 612b in some implementations.

In one or more embodiments, the radial-repeat alignment system 106 determines the angular position of a given object instance based on the positioning of the object instances 604a-604g along the circle 610. For instance, the object instances 604a-604g of the radial-repeat object 602 are positioned at regular intervals along the circle 610. Thus, each pair of object instances are separated by the same angular distance. Further, in some cases, the radial-repeat alignment system 106 determines the start angle based on the positioning (e.g., with the start angle being the angle of the first object instance from the positive x-axis 612a in a counter-clockwise direction). Thus, in some embodiments, the radial-repeat alignment system 106 determines that the angular position of a given object instance is equal to the starting angle plus the multiple of the angular distance separating pairs of object instances as determined by the index of the given object instance.

As an illustration, in some cases, the radial-repeat alignment system 106 associates the object instance 604b with an index of zero as the first object instance after the positive x-axis 612a in the counter-clockwise direction. Accordingly, the radial-repeat alignment system 106 determines that the angular position 608 of the object instance 604b is equal to the starting angle. It should be understood, however, that the approach described above is a generalized approach that facilitates the determination of the angular position even when one of the other object instances are selected.

As shown in FIG. 6C, the radial-repeat alignment system 106 further determines a reference angle 614 (represented as θ_{R}). In particular, FIG. 6C illustrates the radial-repeat alignment system 106 determining the reference angle 614 using the positive y-axis 612b as a reference axis. Thus, as indicated, the radial-repeat alignment system 106 determines the reference angle 614 to equal ninety degrees from the positive x-axis 612a.

The radial-repeat alignment system 106 uses various reference axes in various embodiments. Indeed, in some cases, the radial-repeat alignment system 106 uses the negative x-axis 612c, the negative y-axis 612d, or the positive x-axis 612a as the reference axis. In some cases, the radial-repeat alignment system 106 uses the positive y-axis 612b as the reference axis by default. In some cases, the radial-repeat alignment system 106 changes the reference axis used based on user input.

As further shown in FIG. 6C, the radial-repeat alignment system 106 determines an angular distance 616 (represented as θ_{D}) for the object instance 604b. In one or more embodiments, the angular distance 616 includes the angular distance between the object instance 604b (e.g., with respect to the central point 618) and the reference axis (e.g., the positive y-axis 612b). Accordingly, in some embodiments, the radial-repeat alignment system 106 determines the angular distance 616 for the object instance 604b by determining the difference between the reference angle 614 and the angular position 608 of the object instance 604b (e.g., θ_{R}-θᵢ).

As shown in FIG. 6D, the radial-repeat alignment system 106 determines a logical repositioning for the object instance 604b (e.g., represented by the arrow 620). In particular, as shown, the radial-repeat alignment system 106 determines a logical repositioning for placing the object instance 604b at an upright position directly above the center point 606 of the radial-repeat object 602 (e.g., placing the central point 618 of the object instance 604b on the positive y-axis 612b). For instance, in one or more embodiments, the radial-repeat alignment system 106 determines one or more logical operations to perform to logically reposition the object instance 604b at the upright position directly above the center point 606 of the radial-repeat object 602.

In one or more embodiments, the radial-repeat alignment system 106 determines how to logically reposition the object instance 604b at other positions on the circle 610. For instance, in some cases, the radial-repeat alignment system 106 determines how to logically reposition the object instance 604b at the positive x-axis 612a, the negative x-axis 612c, or the negative y-axis 612d. In some cases, the radial-repeat alignment system 106 determines how to logically reposition the object instance 604b on an axis as this allows for the most precise determination of the radii of the radial-repeat object 602. In other embodiments, however, the radial-repeat alignment system 106 determines how to logically reposition the object instance 604b at a position on the circle between the various axes.

In one or more embodiments, the radial-repeat alignment system 106 determines the logical repositioning for the object instance 604b by establishing the center point 606 for the radial-repeat object 602 as the reference point of rotation. The radial-repeat alignment system 106 further determines an affine transformation matrix for an angular movement of the object instance 604b by an angle that is equal to the angular distance 616. In some embodiments, the radial-repeat alignment system 106 defines an affine transformation matrix T in two-dimensional space as follows:

$$[ T ] = [ \begin{matrix}a & b & {t}_{x} \\ c & d & {t}_{y} \\ 0 & 0 & 1\end{matrix} ] \qquad ( 1 )$$

In equation 1, a and d represent scaling, b and c represent shear and rotation, and tₓ and t_{y} represent translation. In one or more embodiments, the radial-repeat alignment system 106 determines the affine transformation matrix based on various logical operations. Indeed, as described above, in some cases, the radial-repeat alignment system 106 determines to logically reposition the object instance 604b using one or more logical translations and one or more logical rotations. Thus, in some cases, the radial-repeat alignment system 106 defines an effective (e.g., logical) transformation matrix T_{effective} for bounds appropriation as follows:

$$[ {T}_{eff} ] = [ {T}_{- ref} ] \cdot [ {T}_{rot} ] \cdot [ {T}_{ref} ] \qquad ( 2 )$$

In equation 2, [T_{-ref}] represents the logical translation required to position the center point 606 of the radial-repeat object 602 at the origin of the digital design portraying the radial-repeat object 602. In some cases, the radial-repeat alignment system 106 defines [T_{-ref}] as follows where (Cₓ, C_{y}) represents the center point 606 of the radial-repeat object 602:

$$[ {T}_{- ref} ] = [ \begin{matrix}1 & 0 & - {C}_{x} \\ 0 & 1 & - {C}_{y} \\ 0 & 0 & 1\end{matrix} ] \qquad ( 3 )$$

Additionally, in equation 2, [Tᵣₒₜ] represents the logical rotation required to achieve an angular movement of the object instance 604b that covers the angular distance 616. In one or more embodiments, the radial-repeat alignment system 106 defines [Tᵣₒₜ] as follows where θ_{d} represents the angular distance 616 (a normalized angular difference between the reference angle 614 and the angular position 608):

$$[ {T}_{rot} ] = [ \begin{matrix}cos ( {θ}_{d} ) & - sin ( {θ}_{d} ) & 0 \\ sin ( {θ}_{d} ) & cos ( {θ}_{d} ) & 0 \\ 0 & 0 & 1\end{matrix} ] \qquad ( 4 )$$

Further, in equation 2, [T_{ref}] represents the logical translation required to reposition the center point 606 of the radial-repeat object 602 back to its initial position. In one or more embodiments, the radial-repeat alignment system 106 defines [T_{ref}] as follows:

$$[ {T}_{ref} ] = [ \begin{matrix}1 & 0 & {C}_{x} \\ 0 & 1 & {C}_{y} \\ 0 & 0 & 1\end{matrix} ] \qquad ( 5 )$$

It should be noted that equation 2 provides a particular order of multiplication among the different matrices represented therein to determine [T_{eff}]. This order of multiplication holds valid when the matrix is post-multiplied to the reference point (e.g., the center point 606 of the radial-repeat object 602). In cases where the matrix is pre-multiplied to the reference point, the radial-repeat alignment system 106 reverses the order of multiplication shown in equation 2 so that the reference point is first translated to the origin of the digital design and then translated back to its initial position.

As shown in FIG. 6E, after determining the logical repositioning of the object instance 604b via the effective transformation matrix T_{effective} (also referred to as the bounds appropriation matrix), the radial-repeat alignment system 106 appropriates the bounds of the object instance 604b as if it were at the upright position directly above the center point 606 of the radial-repeat object 602. In particular, in some embodiments, the radial-repeat alignment system 106 uses the bounds appropriation matrix to determine the transformed bounds 622 of the object instance 604b. As the repositioning of the object instance 604b is a logical repositioning, the radial-repeat alignment system 106 determines the transformed bounds 622 by determining the transformed positioning of each constituent for the object instance 604b. In one or more embodiments, the transformed bounds 622 includes tight axis-aligned bounds, which enables the radial-repeat alignment system 106 to determine the radii of the radial-repeat object 602 with precision regardless of any rotation of the radial-repeat object 602 as a whole or any rotation of the object instance 604b itself.

As shown in FIG. 6F, the radial-repeat alignment system 106 uses the transformed bounds 622 to determine radii for the radial-repeat object 602. In particular, FIG. 6F shows the radial-repeat alignment system 106 determining an inner radius 624 and an outer radius 626 for the radial-repeat object 602. For instance, the radial-repeat alignment system 106 determines the inner radius 624 by determining a distance between the center point 606 of the radial-repeat object 602 and a portion of the transformed bounds 622 closest to the center point 606. Additionally, the radial-repeat alignment system 106 determines the outer radius 626 by determining a distance between the center point 606 and a portion of the transformed bounds 622 farthest from the center point 606. As suggested above, in some cases, the radial-repeat alignment system 106 additionally or alternatively determines a middle radius for the radial-repeat object 602, such as by determining a distance between the center point 606 of the radial-repeat object 602 and the central point 618 of the object instance 604b at the upright position directly above the center point 606.

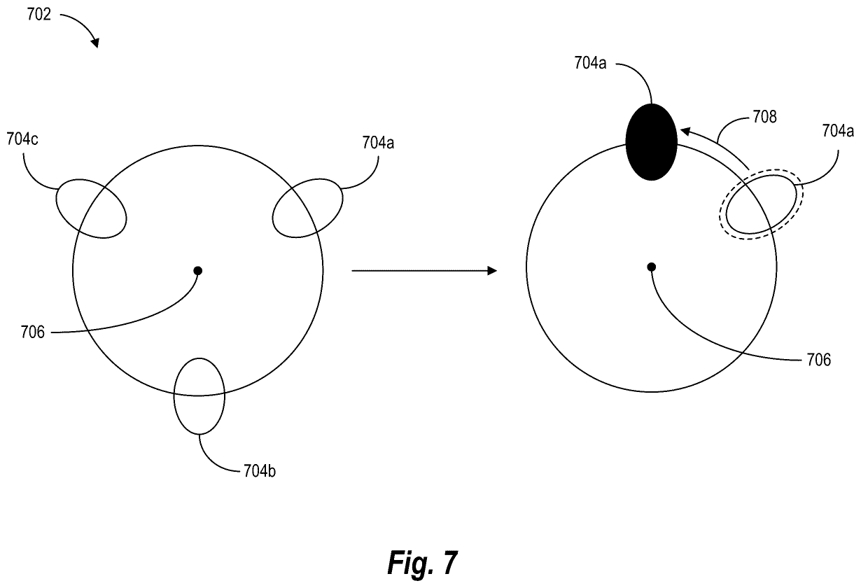

Thus, the radial-repeat alignment system 106 implements a flexible approach to accurately determining radii of a radial-repeat object for use in precisely aligning the radial-repeat object with another radial-repeat object. As previously mentioned, the approach implemented by the radial-repeat alignment system 106 is a generalized approach that facilitates the determination of radii regardless of the configuration of the radial-repeat object under consideration. FIGS. 7-9 illustrate various configurations of radial-repeat objects that are addressed by the bounds appropriation approach of the radial-repeat alignment system 106 in determining radii in accordance with one or more embodiments.

For instance, FIG. 7 illustrates a radial-repeat object 702 having object instances 704a-704c. As shown, none of the object instances 704a-704c are positioned at an upright position directly above a center point 706 of the radial-repeat object 702. As further indicated, however, the radial-repeat alignment system 106 logically repositions the object instance 704a (as represented by the arrow 708) to the upright position directly above the center point 706. In particular, in some embodiments, the radial-repeat alignment system 106 logically repositions the object instance 704a using the bounds appropriation matrix (i.e., the effective transformation matrix) discussed above with reference to FIGS. 6A-6F. Thus, the radial-repeat alignment system 106 can determine radii for the radial-repeat object 702 despite having no object instance positioned at the upright position directly above the center point 706.

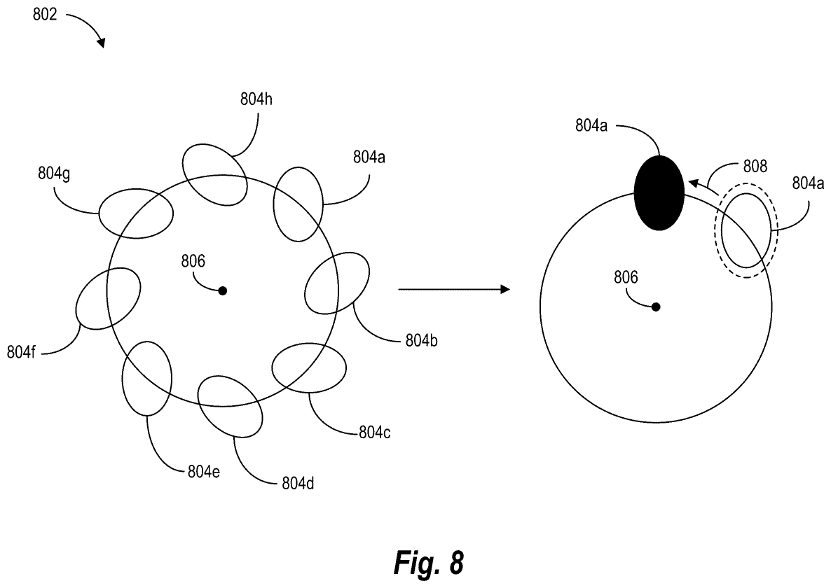

FIG. 8 illustrates a radial-repeat object 802 having object instances 804a-804h. As shown, the radial-repeat object 802 has been rotated so that the object instance 804a that is initially positioned directly above the center point 806 of the radial-repeat object 802 has been relocated. As further shown, however, the radial-repeat alignment system 106 uses the bounds appropriation approach to logically reposition the object instance 804a (as represented by the arow 808) to the upright position directly above the center point 806 (e.g., repositions the object instance 804a back to its original position). Thus, the radial-repeat alignment system 106 can determine radii for the radial-repeat object 802 despite being in a rotated state.

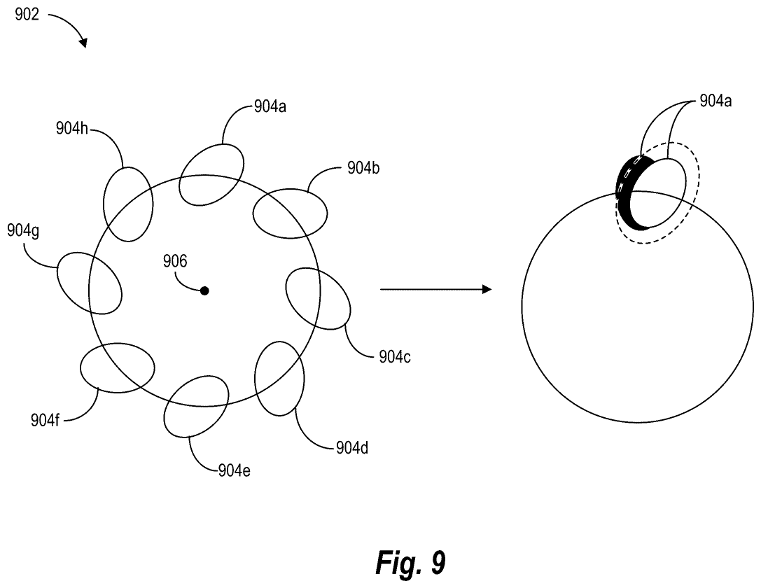

FIG. 9 illustrates a radial-repeat object 902 having object instances 904a-904h. As shown, the object instances of the 904a-904h themselves have been rotated from their initial state. Thus, while the object instance 904a is at its original position above the center point 906 of the radial-repeat object 902, the rotation of the object instance 904a makes the determination of radii of the radial-repeat object 902 difficult if the radial-repeat alignment system 106 attempted to use the object instance 904a as is to determine the radii. As further shown, however, the radial-repeat alignment system 106 uses the bounds appropriation approach to effectively de-rotate the object instance 904a back to its original, un-rotated state. Thus, the radial-repeat alignment system 106 can determine radii for the radial-repeat object 902 despite the object instances 904a-904h being in a rotated state.

Turning now to FIG. 10, additional detail will now be provided regarding various components and capabilities of the radial-repeat alignment system 106. In particular, FIG. 10 illustrates the radial-repeat alignment system 106 implemented by the computing device 1000 (e.g., the server(s) 102 and/or one of the client devices 110a-110n discussed above with reference to FIG. 1). Additionally, the radial-repeat alignment system 106 is also part of the design editing system 104. As shown, in one or more embodiments, the radial-repeat alignment system 106 includes, but is not limited to, a list generator 1002, a radius extractor 1004, an alignment manager 1006, a graphical user interface manager 1008, and data storage 1010 (which includes a list of radial-repeat objects 1012 and object radii 1014).

As just mentioned, and as illustrated in FIG. 10, the radial-repeat alignment system 106 includes the list generator 1002. In one or more embodiments, the list generator 1002 generates a list of radial-repeat objects portrayed within a digital design. For instance, in some embodiments, the list generator 1002 generates a list that maps each radial-repeat object portrayed within the digital design to its corresponding center point. In some cases, the radial-repeat alignment system 106 further filters and sorts the list (e.g., multiple copies of the list) based on detecting a user interaction targeting one of the radial-repeat objects.

Additionally, as shown in FIG. 10, the radial-repeat alignment system 106 includes the radius extractor 1004. In one or more embodiments, the radius extractor 1004 extracts one or more radii from one or more radial-repeat objects portrayed within a digital design (e.g., an inner radius, an outer radius, and/or a middle radius). For instance, in some cases, the radius extractor 1004 determines one or more radii for a radial-repeat object targeted by a user interaction. In some cases, the radius extractor 1004 further determines one or more radii for one or more radial-repeat objects that are concentric with the radial-repeat object targeted by the user interaction. In some cases, the radius extractor 1004 determines the one or more radii for each radial-repeat object via bounds appropriation based on one or more logical operations applied to the radial-repeat object.

Further, as shown in FIG. 10, the radial-repeat alignment system 106 includes the alignment manager 1006. In one or more embodiments, the alignment manager 1006 aligns a radial-repeat object targeted by a user interaction with another radial-repeat object (e.g., a concentric radial-repeat object) portrayed within the digital design. For instance, in some cases, the alignment manager 1006 aligns the radial-repeat objects by aligning their inner radii, their outer radii, or their middle radii. In some cases, the radial-repeat alignment system 106 aligns the radial-repeat objects based on determining that their radii are within a threshold number of pixels (e.g., due to the user interaction modifying the targeted radial-repeat object).

As shown in FIG. 10, the radial-repeat alignment system 106 further includes the graphical user interface manager 1008. In one or more embodiments, the radial-repeat alignment system 106 displays a digital design portraying multiple radial-repeat objects within a graphical user interface of a client device. Further, the graphical user interface manager 1008 displays, within the graphical user interface, changes to the digital design, such as changes to one or more of the portrayed radial-repeat objects. In some cases, upon determining that two radial-repeat objects have been aligned, the graphical user interface manager 1008 generates and provides a visual indication for display within the graphical user interface to indicate the alignment.

As shown in FIG. 10, the radial-repeat alignment system 106 also includes data storage 1010. In particular, data storage 1010 includes the list of radial-repeat objects 1012 (as well as the filtered and/or sorted lists) and the object radii 1014.

Each of the components 1002-1014 of the radial-repeat alignment system 106 optionally include software, hardware, or both. For example, the components 1002-1014 include one or more instructions stored on a computer-readable storage medium and executable by processors of one or more computing devices, such as a client device or server device. When executed by the one or more processors, the computer-executable instructions of the radial-repeat alignment system 106 cause the computing device(s) to perform the methods described herein. Alternatively, the components 1002-1014 include hardware, such as a special-purpose processing device to perform a certain function or group of functions. Alternatively, the components 1002-1014 of the radial-repeat alignment system 106 include a combination of computer-executable instructions and hardware.

Furthermore, the components 1002-1014 of the radial-repeat alignment system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1002-1014 of the radial-repeat alignment system 106 may be implemented as a stand-alone application, such as a desktop or mobile application. Furthermore, the components 1002-1014 of the radial-repeat alignment system 106 may be implemented as one or more web-based applications hosted on a remote server. Alternatively, or additionally, the components 1002-1014 of the radial-repeat alignment system 106 may be implemented in a suite of mobile device applications or “apps.” For example, in one or more embodiments, the radial-repeat alignment system 106 comprises or operates in connection with digital software applications such as ADOBE® PHOTOSHOP® or ADOBE® LIGHTROOM®. The foregoing are either registered trademarks or trademarks of Adobe Inc. in the United States and/or other countries.

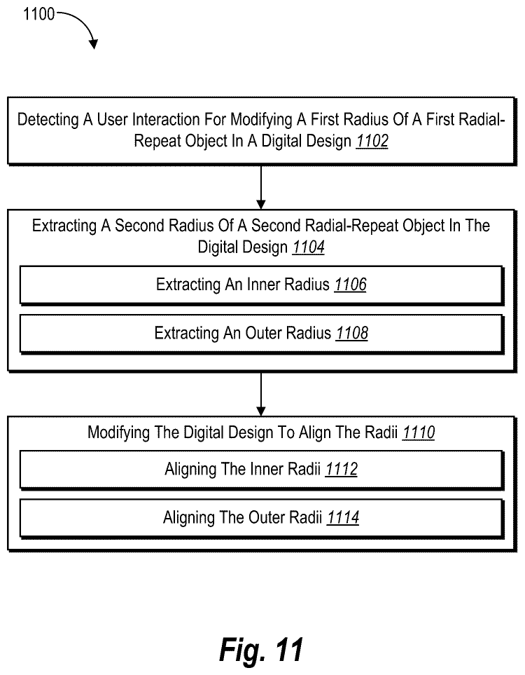

FIGS. 1-10, the corresponding text, and the examples provide a number of different methods, systems, devices, and non-transitory computer-readable media of the radial-repeat alignment system 106. In addition to the foregoing, one or more embodiments can also be described in terms of flowcharts comprising acts for accomplishing the particular result, as shown in FIG. 11. FIG. 11 may be performed with more or fewer acts. Further, the acts may be performed in different orders. Additionally, the acts described herein may be repeated or performed in parallel with one another or in parallel with different instances of the same or similar acts.

FIG. 11 illustrates a flowchart of a series of acts 1100 for aligning radial-repeat objects within a digital design in accordance with one or more embodiments. FIG. 11 illustrates acts according to one embodiment, alternative embodiments may omit, add to, reorder, and/or modify any of the acts shown in FIG. 11. In some implementations, the acts of FIG. 11 are performed as part of a computer-implemented method. Alternatively, a non-transitory computer-readable medium can store executable instructions thereon that, when executed by a processing device, cause the processing device to perform operations comprising the acts of FIG. 11. In some embodiments, a system performs the acts of FIG. 11. For example, in one or more embodiments, a system includes one or more memory devices. The system further includes one or more processors configured to cause the system to perform the acts of FIG. 11.

The series of acts 1100 includes an act 1102 for detecting a user interaction for modifying a first radius of a first radial-repeat object in a digital design. For example, in some cases, the act 1102 involves detecting a user interaction for modifying a first radius of a first radial-repeat object portrayed within a digital design, wherein the first radial-repeat object comprises a first plurality of object instances positioned along a first circumference at the first radius.

Additionally, the series of acts 1100 includes an act 1104 for extracting a second radius of a second radial-repeat object in the digital design. For instance, in one or more embodiments, the act 1104 involves extracting a second radius of a second radial-repeat object portrayed within the digital design, wherein the second radial-repeat object comprises a second plurality of object instances positioned along a second circumference at the second radius.

As shown in FIG. 11, the act 1104 includes a sub-act 1106 for extracting an inner radius. In other words, in some instances, the radial-repeat alignment system 106 extracts the second radius of the second radial-repeat object by extracting the inner radius of the second radial-repeat object. As further shown, the act 1104 includes a sub-act 1108 for extracting an outer radius. Indeed, in some embodiments, the radial-repeat alignment system 106 extracts the second radius of the second radial-repeat object by extracting an outer radius of the second radial-repeat object. In some cases, the radial-repeat alignment system 106 extracts either the inner radius or the outer radius. In others, however, the radial-repeat alignment system 106 extracts both the inner radius and the outer radius.

In one or more embodiments, extracting the second radius of the second radial-repeat object comprises: logically rotating an object instance of the second radial-repeat object to an upright position directly above a center point of the second radial-repeat object; and determining the second radius of the second radial-repeat object using a point of the object instance at the upright position above the center point of the second radial-repeat object. In some cases, the radial-repeat alignment system 106 logically translates the second radial-repeat object from an initial position to an origin of the digital design. Accordingly, in some instances, logically rotating the object instance of the second radial-repeat object to the upright position comprises logically rotating the object instance with the second radial-repeat object logically positioned at the origin of the digital design. In some embodiments, the radial-repeat alignment system 106 further logically translates the second radial-repeat object from the origin of the digital design back to the initial position after logically rotating the object instance to the upright position. As such, in some cases, determining the second radius of the second radial-repeat object comprises determining the second radius with the second radial-repeat object logically positioned at the initial position.

In one or more embodiments, the radial-repeat alignment system 106 selects the second radial-repeat object from a plurality of radial-repeat objects portrayed in the digital design in addition to the first radial-repeat object based on determining that the second radial-repeat object is concentric with the first radial-repeat object. In some embodiments, the radial-repeat alignment system 106 generates a list of radial-repeat objects portrayed in the digital design, the list of radial-repeat objects comprising the second radial-repeat object, and one or more additional radial-repeat objects; and selects, from the list of radial-repeat objects, the second radial-repeat object for alignment with the first radial-repeat object based on determining that the second radius is closer in length to the first radius compared to a radius of the one or more additional radial-repeat objects.

Further, the series of acts 1100 includes an act 1110 for modifying the digital design to align the radii. To illustrate, in some embodiments, the act 1110 involves modifying the digital design, in response to the user interaction, by modifying the first radial-repeat object to align the first radius of the first radial-repeat object with the second radius of the second radial-repeat object.

As shown in FIG. 11, the act 1110 includes a sub-act 1112 for aligning the inner radii. As further shown, the act 1110 includes a sub-act 1114 for aligning the outer radii. In other words, in some cases, modifying the first radial-repeat object to align the first radius of the first radial-repeat object with the second radius of the second radial-repeat object comprises: modifying the first radial-repeat object to align an outer radius of the first radial-repeat object with an outer radius of the second radial-repeat object; or modifying the first radial-repeat object to align an inner radius of the first radial-repeat object with an inner radius of the second radial-repeat object. Further, in certain embodiments, the radial-repeat alignment system modifies the first radial-repeat object to align the inner radius of the first radial-repeat object with the outer radius of the second radial-repeat object; or modifies the first radial-repeat object to align the outer radius of the first radial-repeat object with the inner radius of the second radial-repeat object.

In one or more embodiments, modifying the first radial-repeat object to align the first radius of the first radial-repeat object with the second radius of the second radial-repeat object comprises modifying the first radial-repeat object in response to determining that the first radius is within a threshold number of pixels from the second radius. Further, in some embodiments, the radial-repeat alignment system 106 generates, for display within a graphical user interface of a client device displaying the digital design, a visual guide indicating that the first radius of the first radial-repeat object is aligned with the second radius of the second radial-repeat object.

To provide an illustration, in one or more embodiments, the radial-repeat alignment system 106 generates a list of radial-repeat objects portrayed within a digital design (e.g., a design having vector artwork), wherein each radial-repeat object comprises a plurality of object instances positioned along a corresponding circumference at a radius; detects a user interaction for modifying a first radius of a first radial-repeat object from the list of radial-repeat objects; determines an additional radius for one or more additional radial-repeat objects from the list of radial-repeat objects; selects a second radial-repeat object from the one or more additional radial-repeat objects based on a second radius of the second radial-repeat object and the first radius of the first radial-repeat object; and modifies the digital design, in response to the user interaction, by modifying the first radial-repeat object to align the first radius of the first radial-repeat object with the second radius of the second radial-repeat object.

In one or more embodiments, the radial-repeat alignment system 106 generates the list of radial-repeat objects by generating a mapping of each radial-repeat object portrayed within the digital design to a corresponding center point; and determines the additional radius for the one or more additional radial-repeat objects from the list of radial-repeat objects by determining the additional radius for the one or more additional radial-repeat objects based on determining that the mapping indicates that the one or more additional radial-repeat objects are concentric with the first radial-repeat object.

In some embodiments, the radial-repeat alignment system 106 determines the additional radius for the one or more additional radial-repeat objects from the list of radial-repeat objects by: determining an inner radius for the one or more additional radial-repeat objects; and determining an outer radius for the one or more additional radial-repeat objects. In some instances, the radial-repeat alignment system 106 further determines a first sorting for the list of radial-repeat objects based on the inner radius determined for the one or more additional radial-repeat objects; determines a second sorting for the list of radial-repeat objects based on the outer radius determined for the one or more additional radial-repeat objects; and selects the second radial-repeat object from the one or more additional radial-repeat objects by using the first sorting and the second sorting to identify the second radial-repeat object as having a corresponding radius that is closer in length to the first radius of the first radial-repeat object compared to other radial-repeat objects from the one or more additional radial-repeat objects.

In some cases, the radial-repeat alignment system 106 generates the list of radial-repeat objects portrayed within the digital design by including, within the list of radial-repeat objects, at least one radial-repeat object having a corresponding plurality of object instances positioned at positions other than an upright position directly above a center point of the at least one radial-repeat object; and determines the additional radius for the one or more additional radial-repeat objects by determining at least one additional radius for the at least one radial-repeat object based on logically rotating an object instance from the corresponding plurality of object instances to the upright position directly above the center point of the at least one radial-repeat object. In some implementations, the radial-repeat alignment system 106 further logically translates the at least one radial-repeat object from an initial position to an origin of the digital design before logically rotating the object instance; logically translates the at least one radial-repeat object from the origin of the digital design back to the initial position after logically rotating the object instance; and determines the at least one additional radius for the at least one radial-repeat object after logically translating the at least one radial-repeat object back to the initial position.

In some instances, the radial-repeat alignment system 106 further generates, for display within a graphical user interface of a client device displaying the digital design, a visual guide that highlights the first radius of the first radial-repeat object and the second radius of the second radial-repeat object to indicate alignment of the first radius with the second radius.

To provide another illustration, in one or more embodiments, the radial-repeat alignment system 106 determines, for a first radial-repeat object that is portrayed in a digital design and includes a first plurality of object instances positioned along a first circumference, a first radius corresponding to the first circumference by: logically rotating an object instance of the first radial-repeat object to an upright position directly above a center point of the first radial-repeat object; and determining the first radius using the object instance at the upright position and the center point of the first radial-repeat object; detects a user interaction for modifying a second radius of a second radial-repeat object that is portrayed in the digital design and includes a second plurality of object instances positioned along a second circumference at the second radius; and modifies, in response to the user interaction, the digital design by modifying the second radial-repeat object to align the second radius of the second radial-repeat object with the first radius of the first radial-repeat object.

In some embodiments, the radial-repeat alignment system 106 determines an angular distance between the object instance at an initial position within the first radial-repeat object and a reference axis; and logically rotates the object instance to the upright position directly above the center point of the first radial-repeat object by logically rotating the object instance based on the angular distance. In some cases, the radial-repeat alignment system 106 receives, from a client device displaying the digital design, user input indicating a threshold number of pixels to use in aligning radial-repeat objects; and modifies the second radial-repeat object to align the second radius of the second radial-repeat object with the first radius of the first radial-repeat object by modifying the second radial-repeat object in response to determining that the second radius is within the threshold number of pixels from the first radius.

Further, in one or more embodiments, determining the first radius using the object instance at the upright position and the center point of the first radial-repeat object comprises at least one of: determining an outer radius for the first radial-repeat object as a first distance between a first point of the object instance at an outer boundary of the first radial-repeat object and the center point of the first radial-repeat object; or determining an inner radius for the first radial-repeat object as a second distance between a second point of the object instance at an inner boundary of the first radial-repeat object and the center point of the first radial-repeat object.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., the server(s) 102 and/or the client devices 110a-110n). In one or more embodiments, the computing device 1200 may be a mobile device (e.g., a mobile telephone, a smartphone, a PDA, a tablet, a laptop, a camera, a tracker, a watch, a wearable device). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 including storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
detecting a user interaction for modifying a first radius of a first radial-repeat object portrayed within a digital design, wherein the first radial-repeat object comprises a first plurality of object instances positioned along a first circumference at the first radius;
extracting a second radius of a second radial-repeat object portrayed within the digital design, wherein the second radial-repeat object comprises a second plurality of object instances positioned along a second circumference at the second radius; and
modifying the digital design, in response to the user interaction, by modifying the first radial-repeat object to align the first radius of the first radial-repeat object with the second radius of the second radial-repeat object.

2. The computer-implemented method of claim 1, wherein extracting the second radius of the second radial-repeat object comprises:
logically rotating an object instance of the second radial-repeat object to an upright position directly above a center point of the second radial-repeat object; and
determining the second radius of the second radial-repeat object using a point of the object instance at the upright position above the center point of the second radial-repeat object.

3. The computer-implemented method of claim 2,
further comprising logically translating the second radial-repeat object from an initial position to an origin of the digital design,
wherein logically rotating the object instance of the second radial-repeat object to the upright position comprises logically rotating the object instance with the second radial-repeat object logically positioned at the origin of the digital design.

4. The computer-implemented method of claim 3,
further comprising logically translating the second radial-repeat object from the origin of the digital design back to the initial position after logically rotating the object instance to the upright position,
wherein determining the second radius of the second radial-repeat object comprises determining the second radius with the second radial-repeat object logically positioned at the initial position.

5. The computer-implemented method of claim 1, further comprising selecting the second radial-repeat object from a plurality of radial-repeat objects portrayed in the digital design in addition to the first radial-repeat object based on determining that the second radial-repeat object is concentric with the first radial-repeat object.

6. The computer-implemented method of claim 1, further comprising:
generating a list of radial-repeat objects portrayed in the digital design, the list of radial-repeat objects comprising the second radial-repeat object, and one or more additional radial-repeat objects; and
selecting, from the list of radial-repeat objects, the second radial-repeat object for alignment with the first radial-repeat object based on determining that the second radius is closer in length to the first radius compared to a radius of the one or more additional radial-repeat objects.

7. The computer-implemented method of claim 1, wherein modifying the first radial-repeat object to align the first radius of the first radial-repeat object with the second radius of the second radial-repeat object comprises:
modifying the first radial-repeat object to align an outer radius of the first radial-repeat object with an outer radius of the second radial-repeat object;
modifying the first radial-repeat object to align an inner radius of the first radial-repeat object with an inner radius of the second radial-repeat object;
modifying the first radial-repeat object to align the inner radius of the first radial-repeat object with the outer radius of the second radial-repeat object; or
modifying the first radial-repeat object to align the outer radius of the first radial-repeat object with the inner radius of the second radial-repeat object.

8. The computer-implemented method of claim 1, wherein modifying the first radial-repeat object to align the first radius of the first radial-repeat object with the second radius of the second radial-repeat object comprises modifying the first radial-repeat object in response to determining that the first radius is within a threshold number of pixels from the second radius.

9. The computer-implemented method of claim 1, further comprising, generating, for display within a graphical user interface of a client device displaying the digital design, a visual guide indicating that the first radius of the first radial-repeat object is aligned with the second radius of the second radial-repeat object.

10. A system comprising:
one or more memory devices; and
one or more processors configured to cause the system to:
generate a list of radial-repeat objects portrayed within a digital design, wherein each radial-repeat object comprises a plurality of object instances positioned along a corresponding circumference at a radius;
detect a user interaction for modifying a first radius of a first radial-repeat object from the list of radial-repeat objects;
determine an additional radius for one or more additional radial-repeat objects from the list of radial-repeat objects;
select a second radial-repeat object from the one or more additional radial-repeat objects based on a second radius of the second radial-repeat object and the first radius of the first radial-repeat object; and
modify the digital design, in response to the user interaction, by modifying the first radial-repeat object to align the first radius of the first radial-repeat object with the second radius of the second radial-repeat object.

11. The system of claim 10, wherein the one or more processors are configured to cause the system to:
generate the list of radial-repeat objects by generating a mapping of each radial-repeat object portrayed within the digital design to a corresponding center point; and
determine the additional radius for the one or more additional radial-repeat objects from the list of radial-repeat objects by determining the additional radius for the one or more additional radial-repeat objects based on determining that the mapping indicates that the one or more additional radial-repeat objects are concentric with the first radial-repeat object.

12. The system of claim 10, wherein the one or more processors are configured to cause the system to determine the additional radius for the one or more additional radial-repeat objects from the list of radial-repeat objects by:
determining an inner radius for the one or more additional radial-repeat objects; and
determining an outer radius for the one or more additional radial-repeat objects.

13. The system of claim 12, wherein the one or more processors are further configured to cause the system to:
determine a first sorting for the list of radial-repeat objects based on the inner radius determined for the one or more additional radial-repeat objects;
determine a second sorting for the list of radial-repeat objects based on the outer radius determined for the one or more additional radial-repeat objects; and
select the second radial-repeat object from the one or more additional radial-repeat objects by using the first sorting and the second sorting to identify the second radial-repeat object as having a corresponding radius that is closer in length to the first radius of the first radial-repeat object compared to other radial-repeat objects from the one or more additional radial-repeat objects.

14. The system of claim 10, wherein the one or more processors are configured to cause the system to:
generate the list of radial-repeat objects portrayed within the digital design by including, within the list of radial-repeat objects, at least one radial-repeat object having a corresponding plurality of object instances positioned at positions other than an upright position directly above a center point of the at least one radial-repeat object; and
determine the additional radius for the one or more additional radial-repeat objects by determining at least one additional radius for the at least one radial-repeat object based on logically rotating an object instance from the corresponding plurality of object instances to the upright position directly above the center point of the at least one radial-repeat object.

15. The system of claim 14, wherein the one or more processors are further configured to cause the system to:
logically translate the at least one radial-repeat object from an initial position to an origin of the digital design before logically rotating the object instance;
logically translate the at least one radial-repeat object from the origin of the digital design back to the initial position after logically rotating the object instance; and
determine the at least one additional radius for the at least one radial-repeat object after logically translating the at least one radial-repeat object back to the initial position.

16. The system of claim 10, wherein the one or more processors are further configured to cause the system to generate, for display within a graphical user interface of a client device displaying the digital design, a visual guide that highlights the first radius of the first radial-repeat object and the second radius of the second radial-repeat object to indicate alignment of the first radius with the second radius.

17. A non-transitory computer-readable medium storing executable instructions which, when executed by a processing device, cause the processing device to perform operations comprising:
determining, for a first radial-repeat object that is portrayed in a digital design and includes a first plurality of object instances positioned along a first circumference, a first radius corresponding to the first circumference by:
logically rotating an object instance of the first radial-repeat object to an upright position directly above a center point of the first radial-repeat object; and
determining the first radius using the object instance at the upright position and the center point of the first radial-repeat object;
detecting a user interaction for modifying a second radius of a second radial-repeat object that is portrayed in the digital design and includes a second plurality of object instances positioned along a second circumference at the second radius; and
modifying, in response to the user interaction, the digital design by modifying the second radial-repeat object to align the second radius of the second radial-repeat object with the first radius of the first radial-repeat object.

18. The non-transitory computer-readable medium of claim 17, wherein:
the operations further comprise determining an angular distance between the object instance at an initial position within the first radial-repeat object and a reference axis; and
logically rotating the object instance to the upright position directly above the center point of the first radial-repeat object comprises logically rotating the object instance based on the angular distance.

19. The non-transitory computer-readable medium of claim 17, wherein:
the operations further comprising receiving, from a client device displaying the digital design, user input indicating a threshold number of pixels to use in aligning radial-repeat objects; and
modifying the second radial-repeat object to align the second radius of the second radial-repeat object with the first radius of the first radial-repeat object comprises modifying the second radial-repeat object in response to determining that the second radius is within the threshold number of pixels from the first radius.

20. The non-transitory computer-readable medium of claim 17, wherein determining the first radius using the object instance at the upright position and the center point of the first radial-repeat object comprises at least one of:
determining an outer radius for the first radial-repeat object as a first distance between a first point of the object instance at an outer boundary of the first radial-repeat object and the center point of the first radial-repeat object; or
determining an inner radius for the first radial-repeat object as a second distance between a second point of the object instance at an inner boundary of the first radial-repeat object and the center point of the first radial-repeat object.
